(19) United States
(12) Patent Application Publication
(10) Pub. No.: US 2025/0296246 A1
(43) Pub. Date: Sep. 25, 2025

(54) CABLE-COUPLED ROBOTIC FINGER ACTUATION

(71) Applicant: Sanctuary Cognitive Systems Corporation, Vancouver (CA)

(72) Inventors: Connor Richard Shannon, Vancouver, BC (CA); Brendan Chong, Surrey, BC (CA); Tadas Mitkus, Vancouver (CA)

(21) Appl. No.: 19/087,196

(22) Filed: Mar. 21, 2025

Related U.S. Application Data
(60) Provisional application No. 63/568,367, filed on Mar. 21, 2024.

(51) Int. Cl. B25J 15/02; B25J 15/00

(52) U.S. Cl. CPC B25J 15/0233; B25J 15/0009

(57) ABSTRACT

A robotic digit includes a digit base and a joint link coupled to the digit base and movable relative to the digit base about a first axis. An input link is coupled to the joint link through a proximal digit segment and movable relative to the proximal digit segment about a second axis. A cable extending along the proximal digit segment has a distal end coupled to the input link. A cable drive is coupled to a proximal end of the cable and operable to displace the cable relative to the proximal digit segment. A main actuator has an output coupled to move the joint link about the first axis. Relative displacement between the cable and the proximal digit segment via operation of the first cable drive or operation of the main actuator causes movement of the input link about the second axis.

### CROSS-REFERENCE TO RELATED APPLICATIONS

This application claims the benefit of U.S. Provisional Application No. 63/568,367, filed Mar. 21, 2024, the content of which is incorporated herein by reference.

### FIELD

The field generally relates to digits for robotic hands and particularly to digit actuation mechanisms.

### BACKGROUND

Robots are machines that can sense their environments and perform tasks autonomously or semi-autonomously or via teleoperation. Humanoid robots are robots having an appearance and/or character resembling that of a human. There is considerable interest in humanoid robots that can function as collaborators with humans in diverse applications, such as construction, manufacturing, monitoring, exploration, learning, and entertainment. Such robots may perform tasks in a similar way to how humans perform tasks.

Robots can have end effectors to use in performing tasks. The end effectors of humanoid robots may resemble hands in form and function and may be referred to as robotic hands. An end effector, or a robotic hand, can include robotic digits (or fingers). Each digit may have one or more actuated joints that enable the digit to have one or more degrees of freedom. A digit may need relatively large forces to grasp some objects and relatively small forces to grasp other objects, requiring that the digit actuation is able to accommodate a range of forces to grasp different types of objects. The size of actuators that can be integrated into a digit is constrained by the size of the digit.

### SUMMARY

Disclosed herein are robotic digits with actuated joints and mechanisms for actuating the joints. The robotic digits can be incorporated into robotic hands, which may be used for performance of dexterous manipulation.

In a representative example, a robotic digit includes a digit base. A joint link is coupled to the digit base and movable relative to the digit base about a first axis. A proximal digit segment is coupled to the joint link. An input link is coupled to the proximal digit segment. The input link is movable relative to the proximal digit segment about a second axis. The second axis may be parallel to the first axis in a neutral position of the proximal digit segment. A first cable extends along the proximal digit segment. A distal end of the first cable is coupled to the input link. A first cable drive is coupled to a proximal end of the first cable and operable to displace the first cable relative to the proximal digit segment. A main actuator includes an output that is coupled to the joint link. The main actuator is operable to move the joint link about the first axis. Movement of the joint link about the first axis causes relative displacement between the first cable and the proximal digit segment. Relative displacement between the first cable and the proximal digit segment via operation of the first cable drive or operation of the main actuator causes movement of the input link about the second axis.

In another representative example, a robotic arm includes a forearm and a hand coupled to the forearm. The hand includes at least one digit. The digit includes a digit base, a joint link coupled to the digit base and movable relative to the digit base about a first axis, a proximal digit segment coupled to the joint link, and an input link coupled to the proximal digit link. The input link is movable relative to the proximal digit segment about a second axis, which may be parallel to the first axis in a neutral position of the proximal digit segment. The digit includes a first cable extending along the proximal digit segment and having a distal end coupled to the input link. A first cable drive is coupled to a proximal end of the first cable and is operable to displace the first cable relative to the proximal digit segment. A main actuator has an output coupled to the joint link and is operable to move the joint link about the first axis. Movement of the joint link about the first axis causes relative displacement between the first cable and the proximal digit segment. Relative displacement between the first cable and the proximal digit segment via operation of the first cable drive or operation of the main actuator causes movement of the input link about the second axis. At least one of the first cable drive or the main actuator is disposed in the forearm.

In another representative example, a method of actuating a robotic digit includes operating a main actuator having an output coupled to a joint link to rotate the joint link about a first axis. An input link is coupled to the joint link through a proximal digit segment. A distal end of a cable extending along the proximal digit segment is coupled to the input link. Rotation of the joint link about the first axis causes relative movement between the cable and the proximal digit segment and a corresponding rotation of the input link about a second axis. The method includes operating a cable drive actuator coupled to a proximal end of the cable to cause further rotation of the input link about the second axis.

### BRIEF DESCRIPTION OF THE DRAWINGS

FIG. 1 is a projection view of a robotic digit according to one example.

FIGS. 2A and 2B are side and top views, respectively, of an example actuation mechanism for the robotic digit shown in FIG. 1.

FIGS. 3A and 3B are side and top views, respectively, of another example actuation mechanism for the robotic digit shown in FIG. 1.

FIGS. 4A-4G are projection views of a robotic digit according to another example with varying levels of details to highlight different parts of the robotic digit.

FIGS. 5A-5C illustrate flexion movements of the robotic digit shown in FIGS. 4A-4G.

FIGS. 5D-5F illustrate abduction movements of the robotic digit shown in FIGS. 4A-4D.

FIG. 5G is a projection view of the robotic digit shown in FIGS. 4A-4G with digit abduction and flexion according to one example.

FIG. 5H is projection view of the robotic digit shown in FIGS. 4A-4G with digit abduction and flexion according to another example.

FIGS. 6A and 6B are side and top views, respectively, illustrating external cable actuation of an MCP joint of the robotic digit shown in FIGS. 4A-4G.

FIGS. 7A and 7B are side and top views, respectively, illustrating external cable actuation of a PIP joint of the robotic digit shown in FIGS. 4A-4G.

FIGS. 8A and 8B are side and top views, respectively, illustrating external cable actuation of MCP and PIP joints of the robotic digit shown in FIGS. 4A-4G.

FIG. 9 is a schematic of a robot illustrating positioning of a cable drive in a forearm of the robot for actuation of a digit of the robot.

### DETAILED DESCRIPTION

In this detailed description, certain specific details are set forth herein to provide a thorough understanding of disclosed technology. In some cases, as will be recognized by one skilled in the art, the disclosed technology may be practiced without one or more of these specific details, or may be practiced with other methods, structures, and materials not specifically disclosed herein. In some instances, well-known structures and/or processes associated with robots have been omitted to avoid obscuring novel and non-obvious aspects of the disclosed technology.

All the examples of the disclosed technology described herein and shown in the drawings may be combined without any restrictions to form any number of combinations, unless the context clearly dictates otherwise, such as if the proposed combination involves elements that are incompatible or mutually exclusive. The sequential order of the acts in any process described herein may be rearranged, unless the context clearly dictates otherwise, such as if one act or operation requests the result of another act or operation as input.

In the interest of conciseness, and for the sake of continuity in the description, same or similar reference characters may be used for same or similar elements in different figures, and description of an element in one figure will be deemed to carry over when the element appears in other figures with the same or similar reference character, unless stated otherwise. In some cases, the term “corresponding to” may be used to describe correspondence between elements of different figures. In an example usage, when an element in a first figure is described as corresponding to another element in a second figure, the element in the first figure is deemed to have the characteristics of the other element in the second figure, and vice versa, unless stated otherwise.

The word “comprise” and derivatives thereof, such as “comprises” and “comprising”, are to be construed in an open, inclusive sense, that is, as “including, but not limited to”. The singular forms “a”, “an”, “at least one”, and “the” include plural referents, unless the context dictates otherwise. The term “and/or”, when used between the last two elements of a list of elements, means any one or more of the listed elements. The term “or” is generally employed in its broadest sense, that is, as meaning “and/or”, unless the context clearly dictates otherwise. When used to describe a range of dimensions, the phrase “between X and Y” represents a range that includes X and Y. As used herein, an “apparatus” may refer to any individual device, collection of devices, part of a device, or collections of parts of devices.

The term “coupled” without a qualifier generally means physically coupled or lined and does not exclude the presence of intermediate elements between the coupled elements absent specific contrary language. The term “plurality” or “plural” when used together with an element means a multiple number of the element. Directions and other relative references (e.g., inner and outer, upper and lower, above and below, and left and right) may be used to facilitate discussion of the drawings and principles but are not intended to be limiting.

The headings and Abstract are provided for convenience only and are not intended, and should not be construed, to interpret the scope or meaning of the disclosed technology.

### Example I—Robotic Digit With Cable Actuation

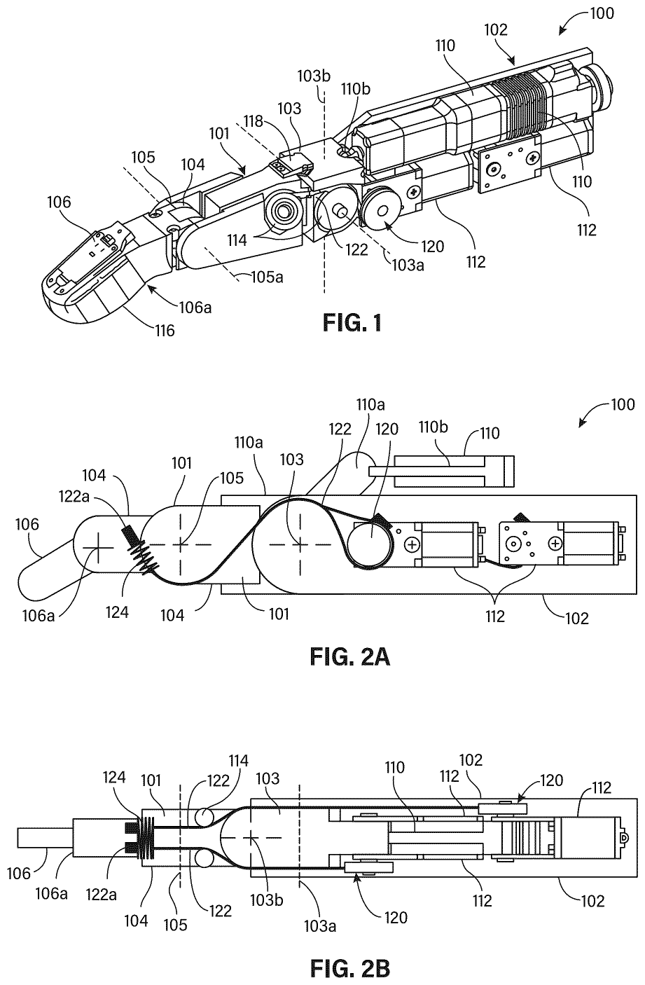

FIG. 1 is a schematic drawing of an example implementation of a robotic digit 100 (or robotic finger) shown obliquely from above. The digit 100 may be analogous to a human finger; therefore, the robotic digit 100 is described below in terms that can be used to describe corresponding anatomical features of a human digit (e.g., a thumb or a finger). The digit 100 may comprise a metacarpophalangeal (MCP) joint 103 (which may be referred to in examples herein as a first flexible coupling), a proximal interphalangeal (PIP) joint 105 (which may be referred to in examples herein as a second flexible coupling), and a distal interphalangeal (DIP) joint 106a (which may be referred to in examples herein as a third flexible coupling).

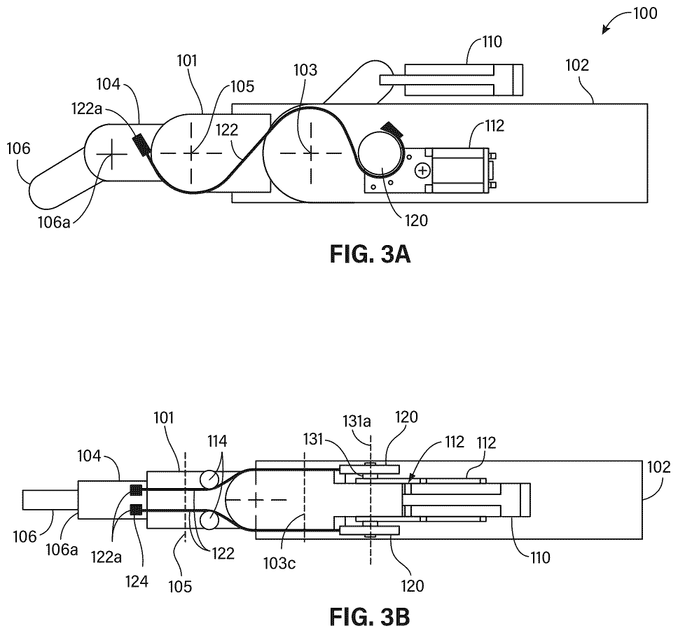

The MCP joint 103 joins a metacarpal 102 (which may be referred to herein as a first segment of the digit) and a proximal phalanx 101 (which may be referred to herein as a second segment of the digit). The MCP joint 103 enables relative movement between the metacarpal 102 and the proximal phalanx 101 about one or more axes of rotation. In some examples, the MCP joint 103 may be an axle, pivot, or hinge enabling movement of the proximal phalanx 101 relative to the metacarpal 102 about a single axis (e.g., axis 103c in the example shown in FIGS. 3A and 3B). In other examples, the MCP joint 103 may be configured to enable movement of the proximal phalanx 101 relative to the metacarpal 102 about each of two orthogonal axes (e.g., axes 103a, 103b in FIG. 1). In yet other examples, the MCP joint 103 may comprise a spherical joint allowing movement about each of three orthogonal axes of rotation. The MCP joint 103 may be configured to enable flexion only or both flexion and abduction of the proximal phalanx 101 relative to the metacarpal 102.

The PIP joint 105 joins the proximal phalanx 101 and an intermediate phalanx 104 (which may be referred to herein as a third segment of the digit) and may allow relative movement between the phalanges 101, 104 at least about one axis (i.e., a hinge, axle or pivot axis), which may be parallel to the axis 103a at the MCP joint 103 in at least a neutral position of the proximal phalanx 101).

The DIP joint 106a joins the middle phalanx 104 and a distal phalanx 106 (which may be referred to herein as a fourth segment of the digit). The DIP joint 106a in some examples may be fixed, wherein the distal phalanx 106 is in fixed relationship to the middle phalanx 104; in other examples, the DIP joint 106a may pivot about one axis (or more) as does the PIP joint 105.

In the present example implementation, as shown more clearly in FIGS. 2A and 2B, a biomimetic actuation mechanism uses cables 122 (e.g., steel cables or tungsten cables or high-strength, low-stretch synthetic cables) to flexurally couple the MCP joint 103 and the PIP joint 105 of the digit 100 (or, expressed differently, connects the metacarpal 102 to the distal phalanx 106) so that the MCP joint 103 and PIP joint 105 can have equal bend angles during flexion movement.

In some examples, the cables 122 can be attached at one end to corresponding small actuators 112 using, for example, capstan drive 120. The small actuators 112 can be non-backdrivable actuators. Operation of the small actuators 112 affects an offset angle between the PIP joint 105 and the MCP joint 103. In some examples, operation of the small actuators 112 may as well cause finger abduction. The small actuator(s) 112 may be coupled to a part of the digit 100, e.g., on the metacarpal 102, on an opposed side of the MCP joint 105 to where the proximal phalanx 101 is coupled.

Using such cable-coupled structure, a single, large actuator (the “main actuator” 110) can provide substantially all the gripping force of the digit 100, with the small actuators 112 providing weaker dexterous motions as well as allowing a hand using such digits to conform to objects it is grasping. Payload capacity of the digit 100 can be increased merely by increasing the strength of the main actuator 110. A similar design can be used for two or three degree of freedom (DOF) robotic digits. The main actuator 110 may be hydraulic, such as a ram and cylinder, or may be electric, such as a linear actuator or motor/ball nut/jack screw combination.

FIG. 1 shows one of the small actuators 112. In some examples, a second such small actuator (e.g., as shown in FIGS. 1, 2B, and 3B) may be disposed on the opposed side of the digit 100. An output shaft 110b of the main actuator 110 may be coupled by a suitable linkage 110a such that extension and retraction of the main actuator 110 causes corresponding flexion motion of the proximal phalanx 101 with respect to the metacarpal 102.

In the present example implementation, a haptic sensor 116 (shown in FIG. 1) may provide signals corresponding to a force exerted by the distal phalanx 106 (or any other suitable contact surface on the digit 100) on an object contacted by the robotic digit 100. A position encoder 118 may provide signals corresponding to bend angle of the MCP joint 103 (or other joint), which signals in addition to the signals from the haptic sensor 116 may be used by a controller (not shown) to govern movement of the digit 100 as may be desired or required. A position encoder can be arranged at the PIP joint 105 or at any other movable joint for the same purpose as the position encoder 118.

In the present example implementation, the cable 122 may be coupled to a capstan drive 120 operable by the small actuator 112. One or more idler pulleys 114 (shown in FIGS. 1 and 2B) may redirect the cable 122 from the plane of the capstan drive 120 to a connection point, e.g., in the distal phalanx 106 (shown in and explained in more detail with reference to FIGS. 2A through 3B).

FIG. 2A shows a side view of an example implementation of the digit 100 to illustrate a possible arrangement of the cables 122. The main actuator 110 may have its output, e.g., a shaft (110b in FIG. 2A), coupled through a link 110a to the proximal phalanx 101, wherein, extension and retraction of the main actuator 110 and correspondingly the shaft 110b results in flexion movement of the proximal phalanx 101 relative to the metacarpal 102. The cable 122 is shown coupled to the capstan drive 120 such that operation of the small actuator 112 rotates the capstan drive 120, which changes the effective overall length of the cable 122 between the capstan drive 120 and an attachment point 122a of the cable 122 on the distal phalanx 106. In some examples, the end of the cable 122 may be coupled to the attachment point 122a through a spring 124 or similar biasing device to enable fine control of the force applied by the distal phalanx 106. FIG. 2A omits direct illustration of pulleys that may be used to route the cable 122 around the axes of the MCP joint 103 and the PIP joint 105; however, the presence of such pulleys may be inferred by the illustrated shape of the cable 122 between the capstan drive 120 and the connection point 122 (also, see the pulleys 114 in FIG. 1).

In operation, moving the main actuator 110 will cause movement about the MCP joint 103. If the operation of the small actuator(s) 112 is such that the capstan drive 120 is rotationally fixed while the main actuator 110 is moving, the cable 122 will by reason of its attachment point 122a on the distal phalanx 106 result in corresponding motion across the PIP joint 105 when motion is imparted to the MCP joint 103 by the main actuator 110. It will also be appreciated that the amount of force imparted by the main actuator 110 will cause corresponding force to be exerted by the intermediate phalanx 104 and the distal phalanx 106; thus, the gripping force of the digit 100 may be related to the capacity of the main actuator 110. It will also be appreciated that for implementations in which the DIP joint 106a is fixed, the attachment point 122a for the cable 122 may be disposed on the intermediate phalanx 104 rather than on the distal phalanx 106.

A top view of the example implementation of FIG. 2A is shown in FIG. 2B to illustrate certain features. As explained above, a respective small actuator 112 may be disposed proximate to and on either side of the metacarpal 102. Each small actuator 112 may be non-backdrivable. Each small actuator 112 may have a respective capstan drive 120 to which a cable 122 is connected at one end. Each cable 122 may terminate in a corresponding attachment point 122a on the distal phalanx 106 (or on the intermediate phalanx 104 if the DIP joint 106a is fixed). The present example implementation shows the small actuators 112 at different longitudinal positions relative to the metacarpal 102 (see FIG. 2A); the foregoing positions are matters of convenience and to make efficient use of space and may be configured differently in other examples.

As may be inferred from the top view in FIG. 2B, the present example implementation provides for two degrees of freedom of movement through the MCP joint 103. For example, and without limitation, the MCP joint 103 may be a compound hinge having a first axis shown at 103a and a second axis shown at 103b (see FIG. 1). The first and second axes 103a, 103b may be mutually perpendicular (or orthogonal), whereby the MCP joint 103 enables both flexion and abduction motion between the metacarpal 102 and the proximal phalanx 101.

In the present example, operation of the main actuator 110 causes flexion motion at the MCP joint 103 (e.g., rotation about the axis 103a). Operating one but not the other of the small actuators 112 may provide abduction motion across the MCP joint 103 (e.g., rotation about the axis 103b). Abduction motion across the MCP joint 103 may also be obtained by operating one of the small actuators 112 in one direction and operating the other small actuator 112 in the opposed direction. Compound motion of both flexion and abduction at the MCP joint 103 may be obtained by suitable operation of both small actuators 112 and the main actuator 110.

To cause flexion motion only at the PIP joint 105, with no abduction motion at the MCP joint 103, the small actuators 112 may be operated synchronously, that is, the direction, timing, and speed of operation of both small actuators 112 may be the same. In this way, no differential force is applied by the cables 122, and all motion across the PIP joint 105 will be flexion. To obtain abduction motion at the MCP joint 103, the small actuators 112 only need to be operated differentially, wherein any or all of speed, timing and direction of motion of the small actuators 112 is not synchronous.

FIGS. 3A and 3B show, respectively, side and top views of an example implementation of the digit 100 wherein the MCP joint 103 provides only rotational movement about a single axis (103c in FIG. 3B), i.e., for flexion motion. In the example illustrated in FIGS. 3A and 3B, there may be only one small actuator 112, and a shaft (e.g., shaft 131 having an axial axis 131a, as shown in FIG. 3B) may connect the capstan drives 120 disposed on either side of the metacarpal 102. Operation of the cables 122 and connection thereof to the middle phalanx 104 (or the distal phalanx 106) may be substantially as explained with reference to FIGS. 2A and 3A.

### Example II—Robotic Digit with Cable Actuation

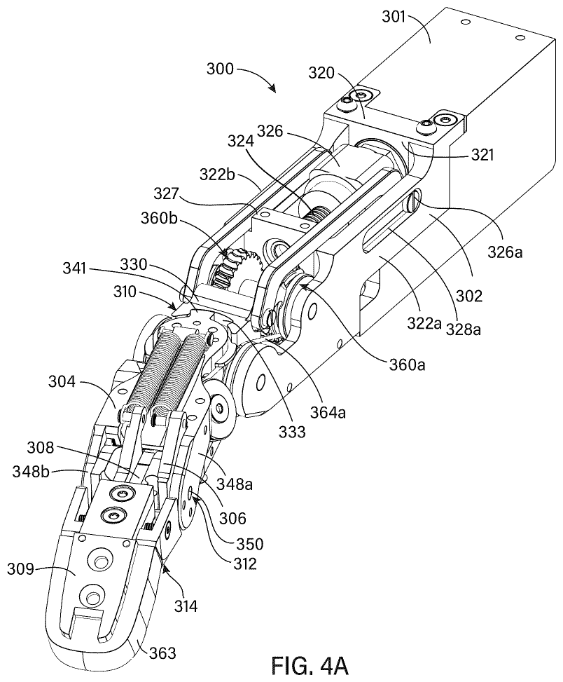

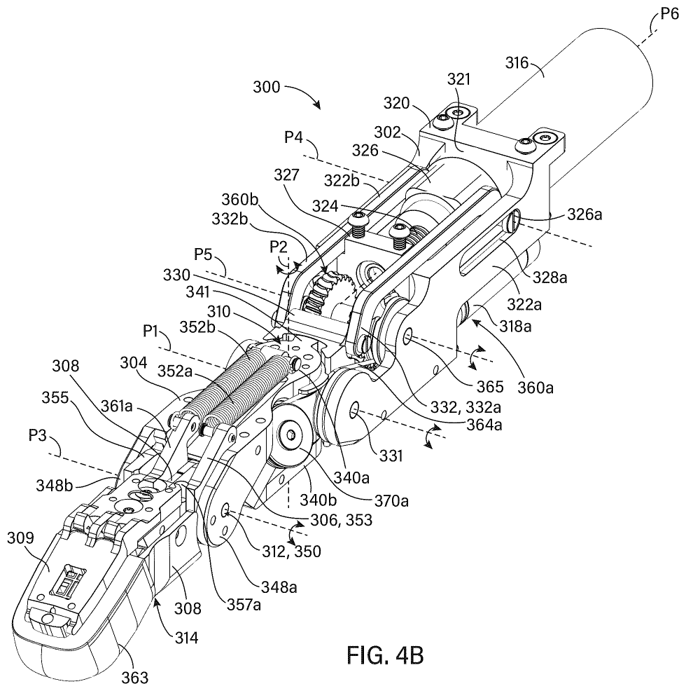

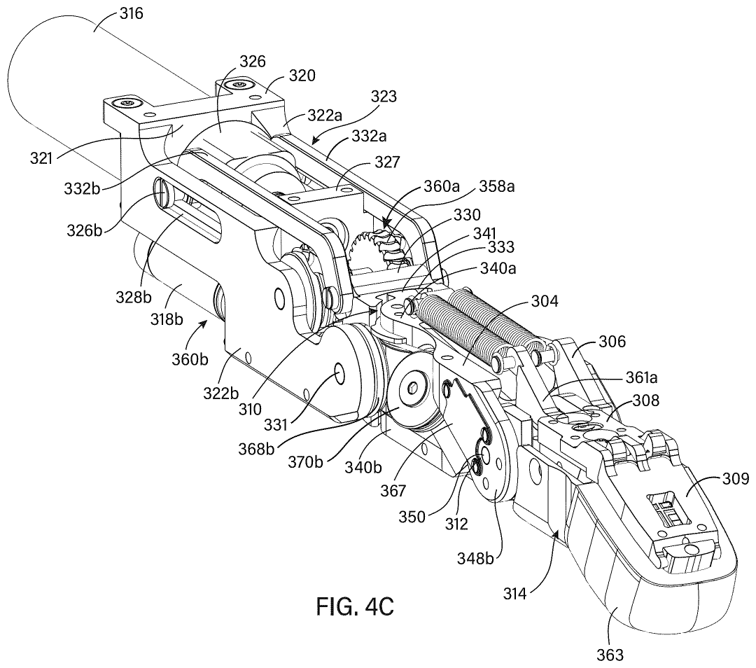

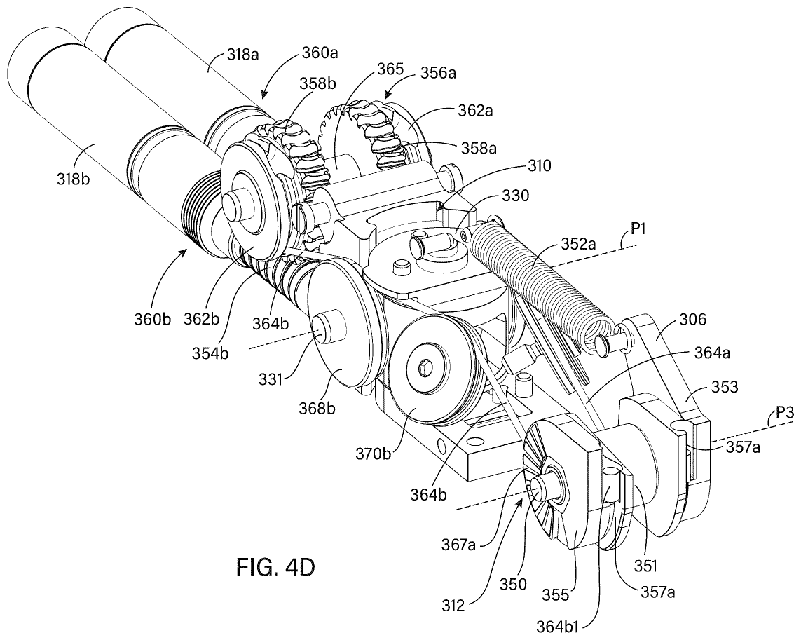

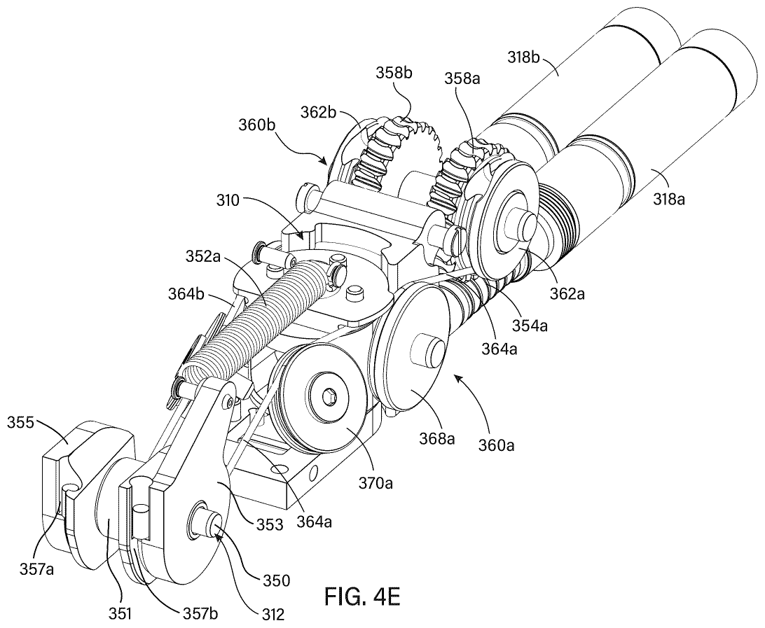

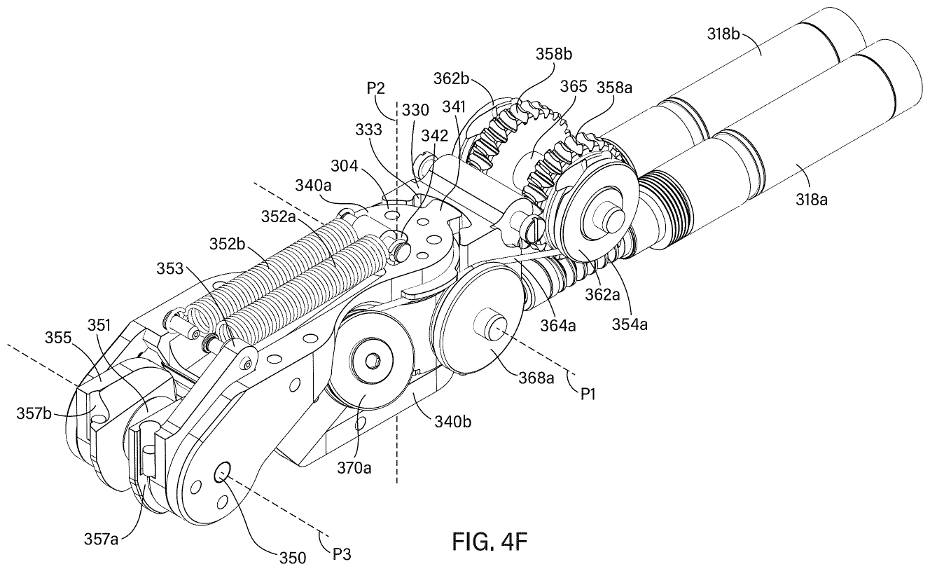

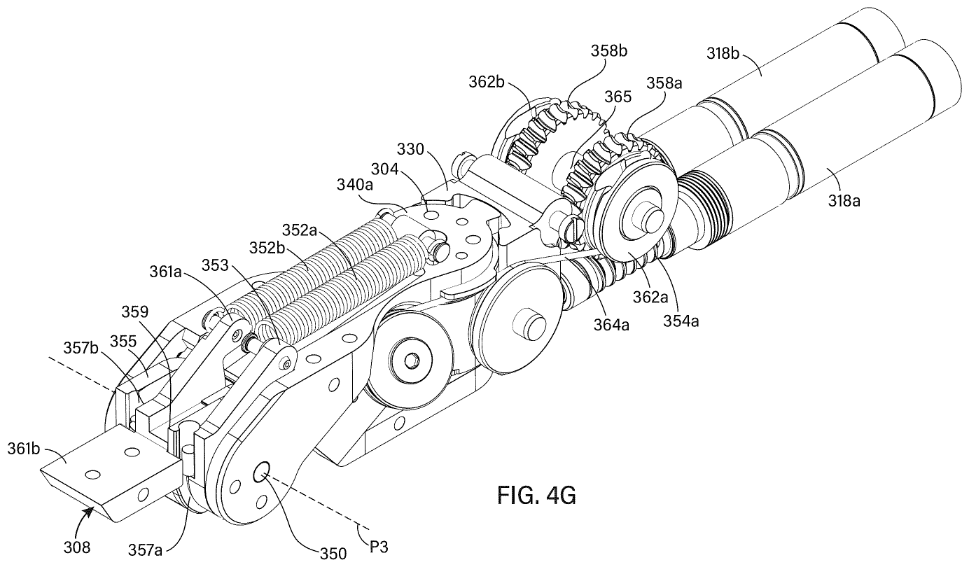

FIG. 4A-4G illustrate a robotic digit 300 according to another example with varying levels of detail. Referring to FIGS. 4A-4C, the robotic digit 300 includes a digit base 302 (which may correspond to a metacarpal). In the example, the digit base 302 is attached to a palm 301 (or a portion of a palm). The digit body of the robotic digit 300 can include a proximal digit segment 304 (which may correspond to a proximal phalanx), which may be coupled to the digit base 302 through an MCP joint 310. The digit body can include a PIP input link 306, which may be coupled to the proximal digit segment 304 through a PIP joint 312. The digit body of the robotic digit 100 can include an intermediate digit segment 308 (which may correspond to an intermediate phalanx). The PIP input link 306 may be coupled to the intermediate digit segment 308 and may serve to actuate the intermediate digit segment 308 in a flexion direction. The digit body of the robotic digit 100 may include a distal digit segment 309 coupled to the intermediate digit segment 308 at a DIP joint 314.

The robotic digit 100 may include one or more cables to actuate one or more joints. In the illustrated example, the robotic digit 100 includes PIP cables 364a, 364b (shown more clearly in FIGS. 4D and 4E) extending along the proximal digit segment 304 (e.g., extending along opposite sides of the proximal digit segment 304). The distal ends of the PIP cables 364a, 364a are attached to the PIP input link 306. The proximal ends of PIP cables 364a, 364b are coupled to PIP cable drives 360a, 360b, which can be operated to move the PIP cables 364a, 364b relative to the proximal digit segment 304 (e.g., in a direction along the proximal digit segment).

In some examples, synchronous operation of the PIP cable drives 360a, 360b resulting in movement of the PIP cables 364a, 364b relative to the proximal digit segment 304 and synchronous motion of the PIP cables 364a, 364b relative to each other causes digit flexion at the PIP joint 312. In alternative examples, movement of a single PIP cable relative to the proximal digit segment 304 (instead of synchronous motion of two cables) may also cause digit flexion at the PIP joint 312. Differential operation of the PIP cable drives 360a, 360b resulting in movement of either or both of the PIP cables 364a, 364b relative to the proximal digit segment 304 and differential motion of the PIP cables 364a, 364b relative to each other causes digit abduction at the MCP joint 310. In some examples, the PIP cable drives 360a, 360b can be internal to the robotic digit 100 (e.g., coupled to the digit base 302) as shown in FIGS. 4A-4G. In other examples, the PIP cable drives 360a, 360b can be external to the robotic digit 100 (e.g., located in a forearm). In both cases, the PIP cable drives 360a, 360b are operatively coupled to the robotic digit 100.

The MCP joint 310 includes an MCP joint link 330, which in the illustrated example is supported by the digit base 302 and pivotable relative to the digit base 302 about an axis P1 (see FIG. 4B). Any manner of pivotably coupling the MCP joint link 330 to the digit base 302 may be used. For example, as shown in FIGS. 4A-4C, the digit base 302 can include a base support 320 and base arms 322a, 322b extending parallel to each other from the base support 320 and spaced apart from each other. The MCP joint link 330 may be disposed in the space between the base arms 322a, 322b and may have a hole that can be axially aligned with holes in the base arms 322a, 322b along the axis P1. A pivot member 331 (e.g., a pin or rod or shaft) may be inserted in the axially aligned holes and secured in place to form a pivot joint between the MCP joint link 330 and the base arms 322a, 322b with a pivot axis extending along the axis P1.

In the illustrated example, the proximal digit segment 304 is coupled to the MCP joint link 330 and pivotable relative to the MCP joint link 330 about an axis P2 (see FIG. 4B). In some examples, the axis P2 may be orthogonal to the axis P1. Any manner of pivotably coupling the proximal digit segment 304 to the MCP joint link 330 may be used. For example, the proximal digit segment 304 can include a pair of proximal arms 340a, 340b arranged in parallel and spaced apart. A portion of the MCP joint link 330 may be disposed in the space between the pair of proximal arms 340a, 340b such that holes in the proximal arms 340a, 340b are axially aligned with a hole in the portion of the MCP joint link 330 along the axis P2. A pivot member 342 (e.g., a pin or rod or shaft; see 342 in FIG. 4F) may be inserted in the axially aligned holes and secured in place to form a pivot joint between the MCP joint link 330 and the proximal arms 340a, 340b, with a pivot axis extending along the axis P2.

In some examples, the proximal arm 340a can include a tab 341 that extends radially into a curved slot 333 (see FIG. 4A) in the MCP joint link 330. The tab 341 can move along the curved slot 333 as the proximal digit segment 304 rotates about the axis P2, with the end walls of the curved slot 333 acting as stop limits for movement of the tab 341 and rotation of the proximal digit segment 304 about the axis P2.

The PIP joint 312 can be a pivot joint having a pivot axis extending along an axis P3 (see FIG. 4B). The axis P3 may be orthogonal to the axis P2. The axis P3 may be parallel to the axis P1 in a neutral position of the proximal digit segment 304 relative to the axis P2 (in some examples, the neutral position of the proximal digit segment 304 relative to the axis P2 may correspond to when the tab 341 is in the middle of the curved slot 333 as shown in FIG. 4B). Any manner of pivotably coupling the PIP input link 306 to the proximal digit segment 304 to form the PIP joint 312 may be used. In the illustrated example, the proximal digit segment 304 includes a pair of distal arms 348a, 348b arranged in parallel and spaced apart. The distal arms 348a, 348b may be orthogonal in orientation to the pair of proximal arms 340a, 340b. The PIP input link 306 may be positioned between the distal arms 348a, 348b such that holes in the distal arms 348a, 348b are axially aligned with a hole in the PIP input link 306. A pivot member 350 (e.g., a rod or pin or shaft) may be inserted in the axially aligned holes and secured in place to form the PIP joint 312 between the distal arms 348a, 348b and the PIP input link 306, with a pivot axis extending along the axis P3. In some examples, rotation of the PIP input link 306 on the pivot member 350 may be supported by a bearing.

As shown more clearly in FIGS. 4D-4F, the PIP input link 306 may have a hub 351 that is mounted on the pivot member 350 (e.g., by means of a bearing) and a flange 353 formed at (or otherwise attached to) one end of the hub 351. A flange 355 (e.g., a removable flange) may be mounted on an end portion of the hub 351 remote from the flange 353. The end portion of the hub 351 and the flange 355 may have complementary profiled surfaces to engage each other.

In some examples, the flange 355 may carry a part 367a (see FIG. 4D) of a position encoder 367 (see FIG. 4C) that allows the rotational position of the PIP input link 306 (or of the PIP joint 312) about the axis P3 to be sensed. (Although not shown in the drawings, position encoders may be similarly arranged at the MCP joint to allow the rotational position of the proximal digit segment 304 about the axis P2 and the rotational position of the MCP joint link 330 about the axis P1 to be sensed.)

In some examples, the flanges 353, 355 may have attachment features 357a, 357b for coupling of the distal ends of the PIP cables 364a, 364b to the PIP input link 306. The attachment features 357a, 357b may be, for example, grooves with profiled sections to receive and retain the distal ends of the PIP cables 364a, 364b (see, for example, the identified cable end 364b1 in FIG. 4D).

In the illustrated example, as shown more clearly in FIG. 4G, the intermediate digit segment 308 includes a ring 359 that is supported on the hub 351 (see FIGS. 4D-4F) of the PIP input link 306 (e.g., by means of a bearing) and constrained between the flanges 353, 355 of the PIP input link 306. Since the intermediate digit segment 308 is coupled to the PIP input link 306 via mounting of the ring 359 on the hub 351, the intermediate digit segment 308 can rotate about the axis P3 with the PIP input link 306. The intermediate digit segment 308 can also rotate relative to the PIP input link 306 in that the ring 359 of the intermediate digit segment 308 is not fixed to the hub 351 of the PIP input link 306.

The intermediate digit segment 308 and the PIP input link 306 may be coupled to the proximal digit segment 304 via return springs 352a, 352b. For example, the return spring 352a can couple the flange 353 of the PIP input link 306 to the proximal arm 340a of the proximal digit segment 304, and the return spring 352b can couple a flange 361a attached to the ring 359 of the intermediate digit segment 308 to the proximal arm 340a of the proximal digit segment 304. The return springs 352a, 352b can act to return the intermediate digit segment 308 and PIP input link 306 to their neutral positions after forces causing them to be displaced from their neutral positions are released. The return spring 352a may be omitted if additional cables are coupled to the PIP input link 306 to pull the PIP input link in a direction opposite to the directions in which the PIP cables 364a, 364b pull the PIP input link. The return spring 352b may be omitted if the intermediate digit segment 308 is fixed relative to the PIP input link 306.

The intermediate digit segment 308 may have a distally projecting part 361b (see FIG. 4G) attached to the ring 359. The distal digit segment 309 (see FIGS. 4A-4C) may be attached to the distally projecting part 361b. The distal digit segment 309 provides at least a part of a fingertip structure (e.g., a fingernail). In some examples, a haptic sensor 363 (see FIGS. 4A-4C) may be attached to the distal digit segment 309. In other examples, a dummy fingertip structure may be attached to the distal digit segment 309. In the illustrated example, the DIP joint 314 between the intermediate digit segment 308 and the distal digit segment 309 is fixed, which means that the distal digit segment 309 is fixed or locked relative to the intermediate digit segment 308. In other examples, an actuated DIP joint may be formed between the intermediate digit segment 308 and the distal digit segment 309 that allows the distal digit segment 309 to be movable relative to the intermediate digit segment 308. The DIP joint may be actuated using any suitable method (e.g., via a linkage; or via a separate cable, cable drive, and DIP input link; or via the same cables and drives used for actuating the PIP joint).

Returning to FIGS. 4A-4C, an MCP actuator 316 (which may also be referred to as a “main actuator”) may be situated between the base arms 322a, 322b and supported by the base support 320 of the digit base 302. The MCP actuator 316 can be a linear actuator, which may be a hydraulic actuator or an electric actuator. In some examples, the MCP actuator 316 can be a backdrivable actuator. In other examples, the MCP actuator 316 may be a non-backdrivable actuator. The output of the MCP actuator 316 is coupled to the MCP joint link 330 to rotate the MCP joint link 330 about the axis P1. Any method of coupling the output of the MCP actuator 316 to the MCP joint link 330 (e.g., a mechanical linkage or a cable) may be used.

In the illustrated example, a mechanical linkage 323 used to couple the output of the MCP actuator 316 to the MCP joint link 330 can include a screw shaft 324 (e.g., a lead screw shaft or a ball screw shaft or roller screw shaft) coupled to the output of the MCP actuator 316. The axial axis of the screw shaft 324 can be parallel to an axis P6, which can be an axial axis of the digit base 302 (e.g., the axis P6 can be parallel to the base arms 322a, 322b). In the illustrated example, the axis P1 is orthogonal to the axis P6. The mechanical linkage can include a nut 326 disposed on the screw shaft 324 and held rotationally fixed so that rotation of the screw shaft 324 results in linear displacement of the nut 326 along the screw shaft 324. For example, the nut 326 can have laterally projecting pins 326a, 326b (shown in FIG. 4C) that are received in linear slots 328a, 328b (shown in FIG. 4C) in the adjacent base arms 322a, 322b. The pins 326a, 326b and linear slots 328a, 328b can serve to prevent rotation of the nut 326 and constrain travel of the nut 326 to a linear path. In some examples, a plate member 327 may be positioned distally to the nut 326 to act as a stop member to limit travel of the nut 326 in the distal direction. An end face 321 of the base support 320 may act as a stop member to limit travel of the nut 326 in the proximal direction.

The nut 326 is coupled to the MCP joint link 330 via at least one link such that movement of the nut 326 can result in rotation of the MCP joint link 330 about the axis P1. In the illustrated example, two parallel linkage bars 332a, 332b disposed on opposite sides of the nut 326 and adjacent to the base arms 322a, 322b are used to couple the nut 326 to the MCP joint link 330. The proximal ends of the linkage bars 332a, 332b are coupled to the nut 326 via pivot joints having pivot axes coinciding with an axis P4 (see FIG. 4B), which may be orthogonal to the axis P6 of the digit base 302 or to the axial axis of the screw shaft 324. In some examples, the proximal ends of the linkage bars 332a, 332b may be mounted on the pins 326a, 326b projecting laterally from the nut 326 to form the pivot joints between the linkage bars 332a, 332b and the nut 326.

The PIP cable drives 360a, 360b can include PIP cable drive actuators 318a, 318b (see FIGS. 4D-4G) corresponding to the two PIP cables 364a, 346b. In the illustrated example, the PIP cable drive actuators 318a, 318b are situated between the base arms 322a, 322b and supported by the base support 320. The PIP cable drive actuators 318a, 318b may be arranged side by side (e.g., at the same longitudinal position along the digit base 302) at a different level compared to the MCP actuator 316. Each of the PIP cable drive actuators 318a, 318b may be small (e.g., in size and payload capacity) compared to the MCP actuator 316. In some examples, the PIP cable drive actuators 318a, 318b may be non-backdrivable actuators. The outputs of the PIP cable drive actuators 318a, 318b can be used directly or indirectly to move the PIP cables 364a, 364b relative to the proximal digit segment 304.

In some examples, as shown in FIGS. 4D-4G, the PIP cable drives 360a, 360b may include respective capstan drives 356a, 356b coupled to the output of the respective PIP cable drive actuators 318a, 318b. The capstan drive 356a, 356b can include a respective capstan drive drum 362a, 362b to which a proximal end of the respective PIP cable 364a, 364b is attached. In the illustrated example, the capstan drive drum 362a, 362b is rotatable about an axis P5 (see FIG. 4B), for example, by support on a shaft 365 having an axial axis extending along the axis P5. The opposing ends of the shaft 365 may be mounted on the base arms 322a, 322b. The axis P5 may be orthogonal to the axis P6 of the digit base 302 or parallel to the axis P1 about which the MCP joint link 330 can pivot. The output of the PIP cable drive actuator 318a, 318b may be coupled to the respective capstan drive drum 362a, 362b via a gear arrangement. In the illustrated example, the gear arrangement may include a worm wheel 358a, 358b mounted on the shaft 365 and attached to a respective capstan drive drum 362a, 362b. The gear arrangement may include a worm gear 354a, 354b coupled to the output of a respective PIP cable drive actuator 318a, 318b and enmeshed with a respective worm wheel 358a, 358b.

Each PIP cable 364a, 364b may be, for example, a steel cable or tungsten cable or other suitable high-strength, low-stretch cable. A proximal end of each of the PIP cables 364a, 364b may be coupled to the capstan drive drum 362a, 362b of the respective PIP cable drive 360a, which would allow the PIP cables 364a, 364b to be reeled around the capstan drive drum 362a 362b by operation of the PIP cable drive actuators 318a, 318b. A distal end of each of the PIP cables 364a, 364b is coupled to the PIP input link 306 (e.g., received in the profiled slots (or attachment features) 357a, 357b formed in the flanges 353, 355 of the PIP input link 306).

One or more cable guides may be provided along the digit body for the PIP cables 364a, 364b. The cable guides may provide sliding contact or rolling contact with the PIP cables 364a, 364b. In the illustrated example, idler pulleys 368a, 370a may be disposed on a first side of the digit body to provide two rolling contact cable guides for the PIP cable 364a, and idler pulleys 368b, 370b may be disposed on a second side of the digit body to provide two rolling contact cable guides for the PIP cable 364b. Additional or fewer rolling contact cable guides may be provided for each of the PIP cables 364a, 364b as needed. In the illustrated example, the idler pulleys 368a, 368b are mounted on opposite ends of the pivot member 331 supporting the MCP joint link 330 (see FIGS. 4B and 4C). The idler pulleys 370a, 370b are attached to opposite sides of the proximal digit segment 304 (see FIGS. 4B and 4C). The PIP cables 364a, 364b engage and roll relative to the respective idler pulleys 368a, 368b, 370a, 370b. The idler pulleys 368a, 368b, 370a, 370b guide the motion of the respective PIP cables 364a, 364b. The idler pulleys 368a, 368b, 370a, 370b may also serve the function of maintaining tension in the respective PIP cables 364a, 364b. In other examples, a cable guide that provides sliding contact may be used instead of an idler pulley. For example, a Bowden tube or a slippery material with a cable routing path, both of which provide sliding contact, may be used.

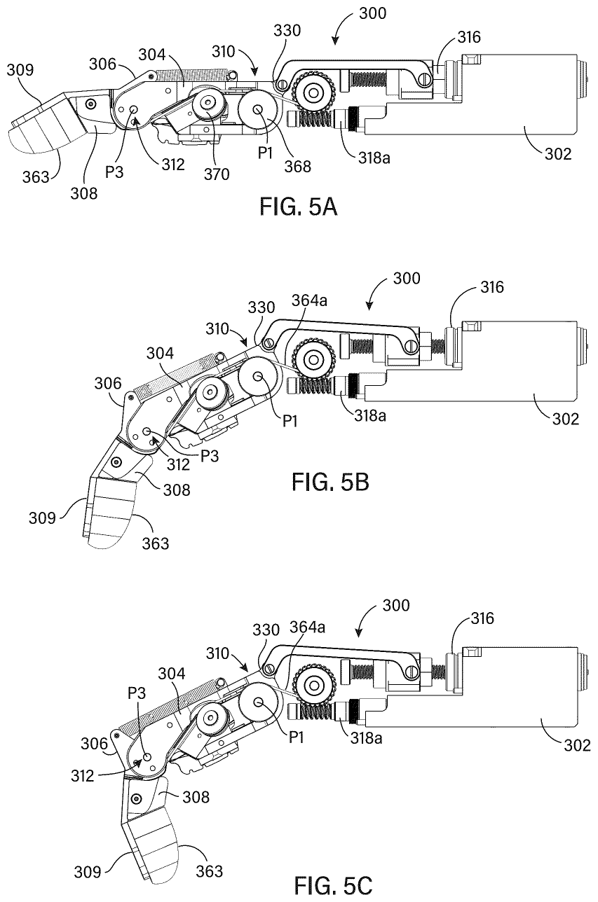

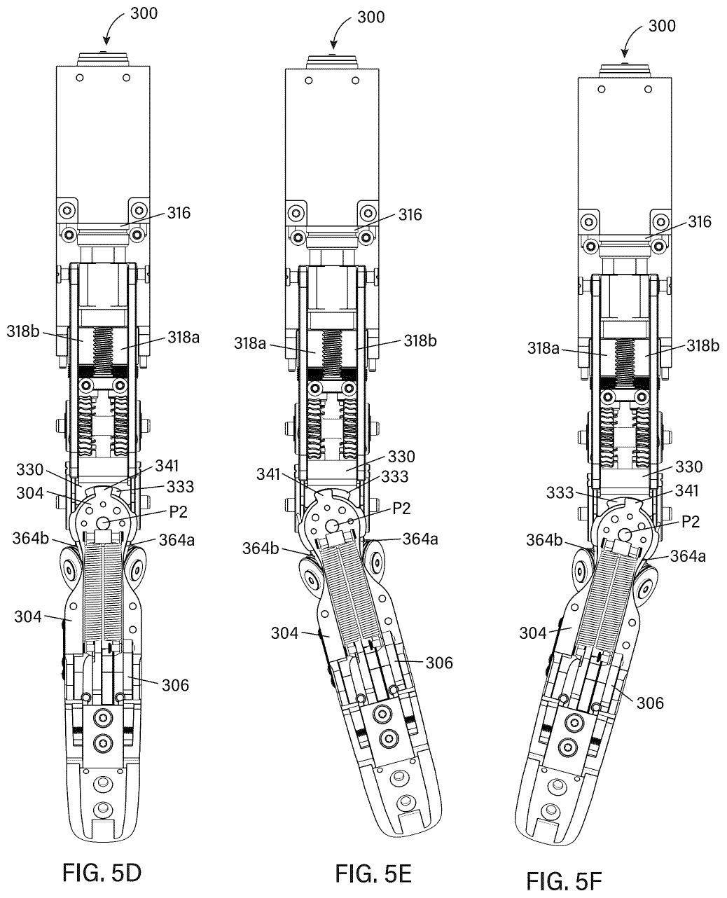

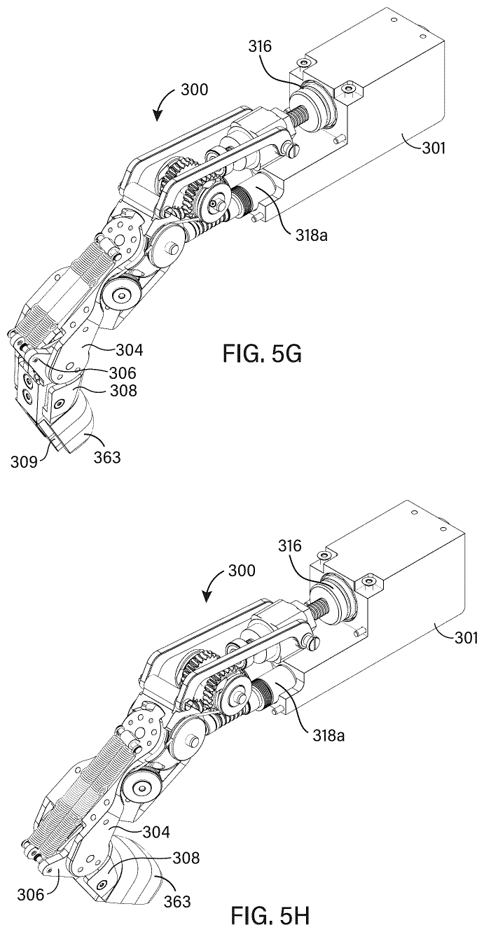

FIGS. 5A-5C illustrate a sequence of movements of the robotic digit 300 according to one example scenario. In FIG. 5A, the robotic digit 300 is in a neutral position (e.g., without abduction or flexion at any of the joints). The MCP actuator 316 can be operated to pivot the MCP joint link 330 about the axis P1 (see FIG. 4B), corresponding to digit flexion at the MCP joint 310. The pose of the robotic digit shown in FIG. 5B corresponds to moving the MCP actuator 316 while the PIP cable drive actuators 318a, 318b are static. Movement of the MCP actuator 316 causes pivoting of the MCP joint link 330 about the axis P1 (e.g., downward movement of the proximal digit segment 304 as shown in FIG. 5B), corresponding to digit flexion at the MCP joint 310. Movement of the MCP joint link 330 about the axis P1 causes relative movement between the proximal digit segment 304 and the PIP cables 364a, 364b, which results in the PIP input link 306 pivoting about the axis P3 (see FIG. 4B), corresponding to digit flexion at the PIP joint 312. Since the PIP cable drive actuators 318a, 318b are static (which means that the lengths of the PIP cables 364a, 364b are not changing), the relative motion between the PIP cables 364a, 364b and the proximal digit segment 304 follows a path to maintain the constant lengths of the PIP cables 364a, 364b. As the MCP actuator 316 moves, the PIP cables 364a, 364b couple motion at the axis P1 to motion at the axis P3. The amount by which the MCP angle (e.g., the angle between the proximal digit segment 304 and the digit base 302) changes due to operation of the MCP actuator 316 produces a corresponding change in the PIP angle (e.g., the angle between the proximal digit segment 304 and the intermediate digit segment 308). In the illustrated example, the ratio of the corresponding change is 1. In other examples, the ratio of the corresponding change may be different (e.g., if the relative diameters of the pulleys 368, 370 are different).

In some examples, the PIP cable drive actuators 318a, 318b can be operated synchronously, resulting in movement of the PIP cables 364a, 364b relative to the proximal digit segment 304 and synchronous motion of the PIP cables 364a, 364b relative to each other. Synchronous motion of the PIP cables 364a, 364b can mean that the lengths of the PIP cables 364a, 364b are changing by the same amount due to synchronous operation of the PIP cable drive actuators 318a, 318b. In synchronous operation, both PIP cable drive actuators 318a, 318b are moving in the same way (e.g., are controlled to the same positions). Synchronous motion of the PIP cables 364a, 364b can pivot the PIP input link 306 about the axis P3, resulting in an offset in the PIP angle that is unrelated to operation of the MCP actuator 316. Suppose that in the example shown in FIG. 5B, PIP angle equals MCP angle, which equals x, where x is some number. In FIG. 5C, the PIP angle is now the sum of x and y, where y is the offset due to pivoting of the PIP input link 306 about the axis P3 by synchronous motion of the PIP cables 364a, 364b. In some examples, the PIP offset is proportional to an average of the change in length of the PIP cables 364a, 364b achieved by the synchronous motion. The PIP offset can be observed by noting the additional bend of the distal digit segment 309 (or the haptic sensor 363) in FIG. 5C compared to in FIG. 5B.

There are scenarios where the PIP offset can be achieved without synchronous operation. In examples where there is a single PIP cable coupled to the PIP input link 306 with one corresponding cable drive actuator, then only the single cable drive actuator is controlled to achieve the PIP offset. Similarly, in examples where two PIP cables are coupled to the PIP input link, but the two PIP cables are driven by the same cable drive actuator, then the single cable drive actuator is controlled to achieve the PIP offset.

The movements illustrated in FIGS. 5B and 5C may be combined. For example, the MCP actuator 316 and PIP cable drive actuators 318a, 318b may be operated simultaneously to pivot the MCP joint link 330 about the axis P1 and pivot the PIP input link 306 about the axis P3. The final PIP angle will be a sum of the PIP angle due to movement of the MCP actuator 316 and the PIP offset angle due to synchronous operation of the PIP cable drive actuators 318a, 318b (or operation of one PIP cable drive actuator if the digit has only one PIP cable drive actuator).

In some examples, the PIP cable drive actuators 318a, 318b can be operated differentially (e.g., the PIP cable drive actuators 318a, 318b are controlled to different positions), resulting in differential motion of the PIP cables 364a, 364b relative to each other. Differential motion of the PIP cables 364a, 364b can mean that the lengths of the PIP cables 364a, 364b change by different amounts due to differential operation of the PIP cable drive actuators 318a, 318b. In differential operation of the PIP cable drive actuators 318a, 318b, both PIP cable drive actuators 318a, 318b may move differently or one of the PIP cable drive actuators 318a, 318b may move while the other PIP cable drive actuator 318a, 318b is static. Differential motion of the PIP cables 364a, 364b can create a torque on the PIP input link 306 that rotates the PIP input link 306 and the proximal digit segment 304 (e.g., as an assembly) about the axis P2, corresponding to digit abduction at the MCP joint 310. The digit abduction may be proportional to the difference between the positions of the PIP cable drive actuators 318a, 318b.

FIG. 5D shows the robotic digit 300 at a neutral position (e.g., without abduction or flexion at any of the joints). In this example, the tab 341 of the proximal digit segment 304 is in the center of the curved slot 333 of the MCP joint link 330. FIG. 5E shows the robotic digit 300 after pivoting of the PIP input link 306 and the proximal digit segment 304 in the counterclockwise direction (relative to the orientation of the robotic digit in the figure) about the axis P2, corresponding to digit abduction in one direction. In FIG. 5E, the change in length of the PIP cable 364b from the neutral position shown in FIG. 5D is greater than the change in length of the PIP cable 364a from the neutral position shown in FIG. 5D. FIG. 5F shows the robotic digit 300 after pivoting of the PIP input link 306 and the proximal digit segment 304 in the clockwise direction (relative to the orientation of the robotic digit in the figure) about the axis P2, corresponding to digit abduction in another direction. In FIG. 5F, the change in the length of the PIP cable 364a from the neutral position shown in FIG. 5D is greater than the change length of the PIP cable 364b from the neutral position shown in FIG. 5D.

The actuations illustrated in FIGS. 5A-5F can be performed in any desired combination to obtain a desired pose of the robotic digit 300. FIG. 5G shows the robotic digit 300 with digit flexion via the MCP actuator 316 and digit abduction via differential operation of the PIP cable drive actuators 318a, 318b. FIG. 5H shows the robotic digit 300 with digit flexion via the MCP actuator 316, PIP offset via synchronous motion of the PIP cable drive actuators 318a, 318b, and digit abduction via differential operation of the PIP cable drive actuators 318a, 318b (the PIP offset is visible in the difference in the angle of the distal digit segment 309 (or haptic sensor 363) between FIGS. 5G and 5H)). Other poses of the robotic digit 300 may be possible if one or more of the actuators have backdrivable features.

Since the MCP actuator 316 can control digit flexion at the MCP joint 310 and the PIP joint 312, the MCP actuator 316 can be sized to provide substantially all the gripping force of the robotic digit 300. The PIP cable drive actuators 318a, 318b can be used for weaker dexterous motions (such as motions to enable the robotic digit to conform to a surface) and can each have a smaller capacity compared to the MCP actuator 316. The MCP actuator 316 can be a backdrivable actuator or a non-backdrivable actuator. The PIP cable drive actuators 318a, 318b can be non-backdrivable actuators. Alternatively, the PIP cable drive actuators 318a, 318b may be backdrivable actuators.

### Example III—Robotic Digit With External MCP Cable Actuation

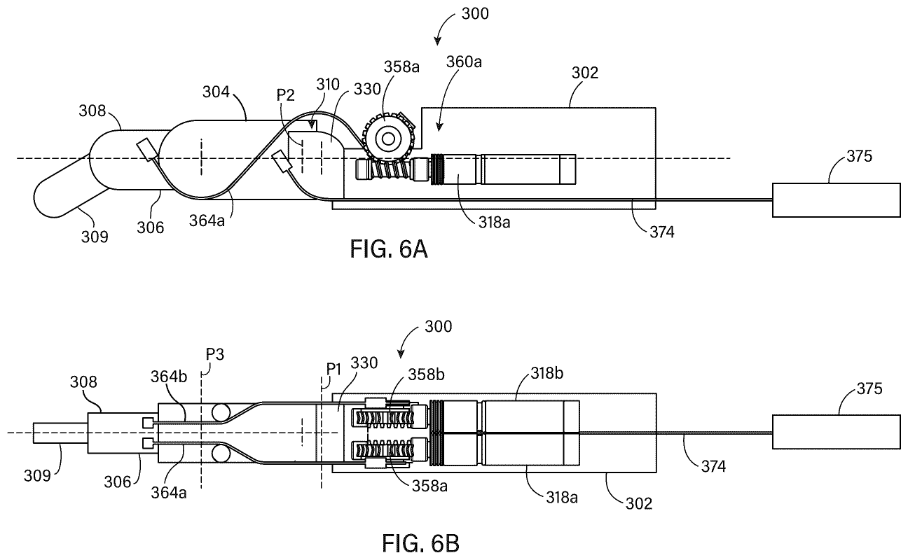

FIGS. 6A and 6B illustrate the robotic digit 300 with an MCP cable 374 and an MCP cable drive 375 taking the place of the MCP actuator 316 and mechanical linkage 323 (see Example II). A distal end of the MCP cable 374 is coupled to the MCP joint link 330. A proximal end of the MCP cable is coupled to the MCP cable drive 375. The details of the MCP cable drive 375 are not shown, but the MCP cable drive 375 could have a similar configuration to either of the PIP cable drives 360a, 360b in some examples. Although not shown, the MCP cable 374 may engage one or more cable guide(s) via sliding contact or rolling contact on its path from the MCP joint link 330 to the MCP cable drive 375. The cable guide may be, for example, an idler pulley, a Bowden tube, or a slippery material with a cable routing path.

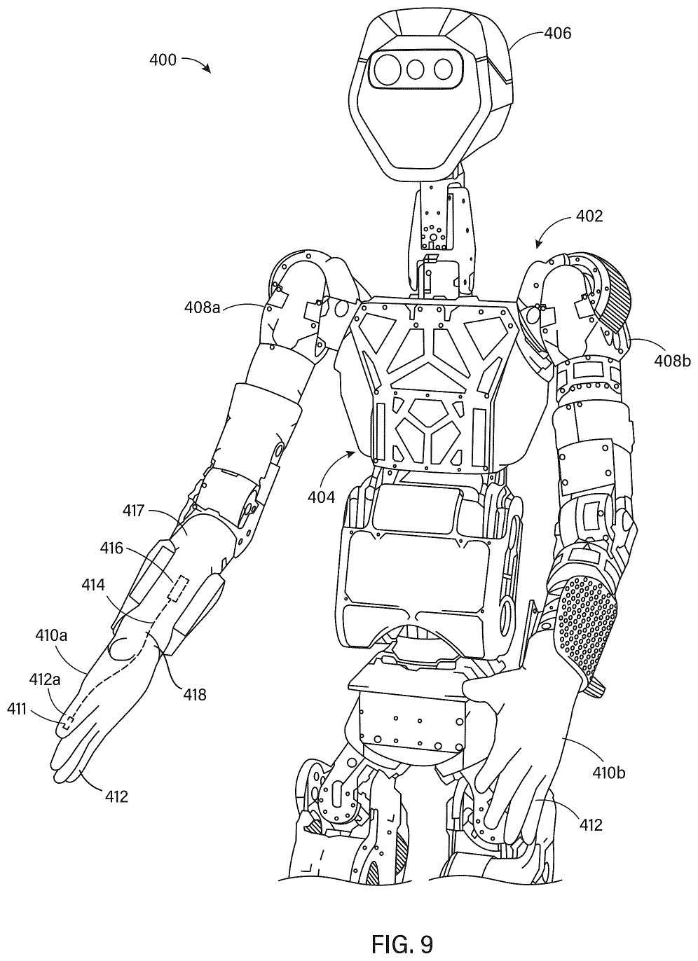

In the illustrated example, the MCP cable drive 375 is located outside the digit base 302. For example, the MCP cable drive 375 may be in a robotic forearm (see forearm 417 in FIG. 9). The MCP cable 374 can extend along the digit base 302 and may pass through or around the wrist of the hand to reach the MCP cable drive 375 located in the robotic forearm. The MCP cable drive 375 can be operated from a remote location (e.g., from a forearm) to adjust the length of the MCP cable 374 and thereby cause rotation of the MCP joint link 330 about the axis P1 (corresponding to digit flexion at the MCP joint 310).

The MCP cable drive 375 can have any suitable configuration to move the MCP cable 374 relative to the digit base 302 (e.g., in a direction along the digit base 302). In some examples, the configuration of the MCP cable drive 375 can be similar to the configuration of either of the PIP cable drives 360a, 360b (shown in FIGS. 4A-4G). For example, the MCP cable drive 375 can include an MCP cable drive actuator (which can be similar to the MCP actuator 316 in FIGS. 4A-4C) having an output that can be coupled to the proximal end of the MCP cable 374. The MCP cable drive actuator may be coupled directly to the MCP cable 374, or the MCP cable drive 375 may include a capstan drive drum (which can be similar to any of the capstan drive drums 362a, 362b in FIGS. 4D-4G) coupled to the output of the MCP cable drive actuator. The proximal end of the MCP cable 374 can be attached to the capstan drive drum so that MCP cable 374 can be displaced relative to the digit base 302 by reeling the MCP cable 374 around the capstan drive drum. The MCP cable drive 375 may include a geared arrangement that may be used to couple the output of the MCP cable drive actuator to the capstan drive drum. For example, the geared arrangement can be a worm gear coupled to the output of the MCP cable drive actuator and a worm wheel coupled to the capstan drive drum and enmeshed with the worm gear (see worm gear 354a, 354b and worm wheel 358, 358b in FIGS. 4D-4G as example geared arrangements).

In the example illustrated in FIGS. 6A and 6B, the PIP cable drives 360a, 360b are coupled to the digit base 302 and operate as described in Example II to cause rotation of the PIP input link 306 about the axis P3 and rotation of the proximal digit segment about the axis P2. Rotation of the MCP joint link 330 about the axis P1 via actuation of the MCP cable 374 can also cause rotation of the PIP input link 306 about the axis P3 as the PIP cables 364a, 364b change form to accommodate rotation of the proximal digit segment 304.

### Example IV—Robotic Digit with External PIP Cable Actuation

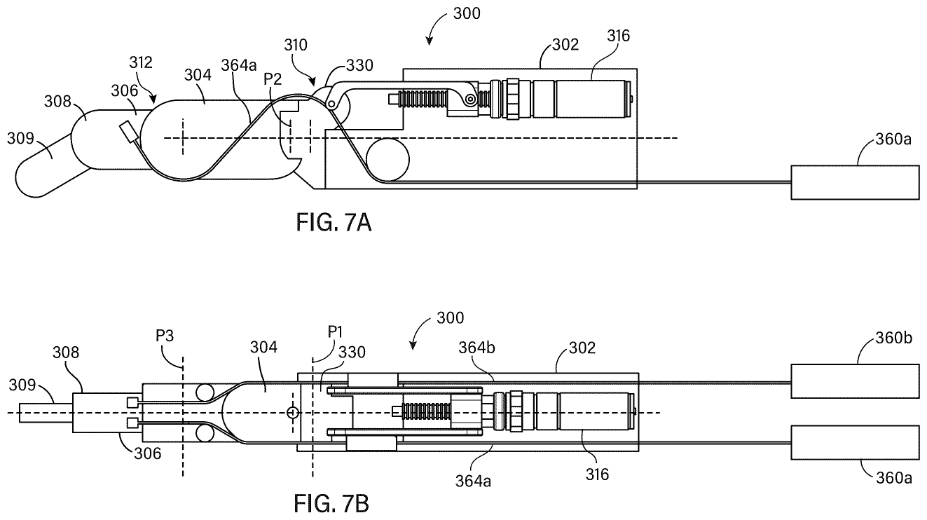

FIGS. 7A and 7B illustrate the robotic digit 300 with the PIP cable drives 360a, 360b (shown in FIGS. 4A-4G) removed from the digit base 302 and placed at a location that is external to the robotic digit 300. For example, the PIP cable drives 360a, 360b may be positioned in the robotic forearm (see forearm 417 in FIG. 9), and the PIP cables 364a, 364b can pass through or around the wrist to reach the PIP cable drives 360a, 360b in the robotic forearm.

The PIP cable drives 360a, 360b can be operated from a remote location (e.g., from a robotic forearm) to displace the PIP cables 364a, 364b relative to the proximal digit segment 304, which can cause rotation of the PIP input link 306 about the axis P3 and rotation of the proximal digit segment 304 about the axis P2, depending on how the PIP cable drives 360a, 360b are controlled. In some examples, rotation of the proximal digit segment 304 about the axis P2 occurs when the PIP cable drives 360a, 360b are operated differentially.

The MCP joint link 330 may be rotated about the axis P1 by the output of the MCP actuator 316 located in the digit base 302, as described in Example II. Rotation of the MCP joint link 330 about the axis P1 can also cause rotation of the PIP input link 306 about the axis P3 as the PIP cables 364a, 364b change form to accommodate rotation of the proximal digit segment.

### Example V—Robotic Digit With External MCP and PIP Cable Actuation

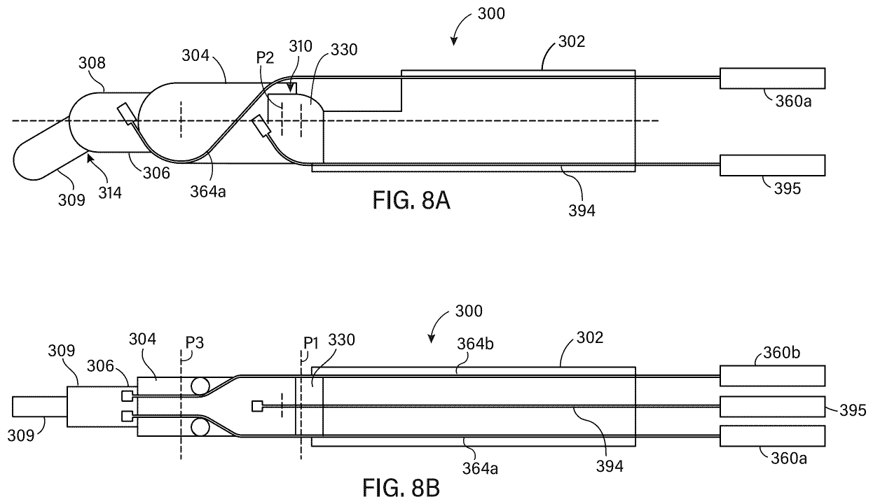

FIGS. 8A and 8B illustrate the robotic digit 300 with an MCP cable 394 and MCP cable drive 395 taking the place of the MCP actuator 316 and mechanical linkage 323 (see Example II). A distal end of the MCP cable 394 is coupled to the MCP joint link 330. A proximal end of the MCP cable 394 is coupled to the MCP cable drive 395. The details of the MCP cable drive 395 are not shown, but the MCP cable drive 395 could have a configuration that is similar to the configuration of either of the PIP cable drives 360a, 360b (shown in FIGS. 4A-4G) in some examples. Although not shown, the MCP cable 394 may be guided by one or more cable guides (e.g., idler pulley(s) or Bowden tube or a slippery material with a cable routing path).

In the illustrated example, the MCP cable drive 395 is located outside the digit base 302. For example, the MCP cable drive 395 may be in a robotic forearm (see forearm 417 in FIG. 9), and the MCP cable 394 may pass through or around the wrist to reach the MCP cable drive 395 located in the robotic forearm. The MCP cable drive 395 can be operated from a remote location (e.g., from a robotic forearm) to displace the MCP cable 394 relative to the digit base 302 (e.g., move the MCP cable 394 along the digit base) and thereby cause rotation of the MCP joint link 370 about the axis P1 (corresponding to digit flexion at the MCP joint 310).

As in Example IV, the PIP cable drives 360a, 360b are placed in a location external to the digit body and digit base. For example, the PIP cable drives 360a, 360b may be in a robotic forearm along with the MCP cable drive 395. The PIP cable drives 360a, 360b can be operated from a remote location (e.g., from a robotic forearm) to displace the PIP cables 364a, 364b relative to the proximal digit segment 304 (e.g., move the PIP cables 364a, 364b along the proximal digit segment 304), which can cause rotation of the PIP input link 306 about the axis P3 and rotation of the proximal digit segment about the axis P2. In some examples, rotation of the proximal digit segment about the axis P2 occurs when the PIP cable drives 360a, 360b are operated differentially.

Rotation of the MCP joint link 330 about the axis P1 (e.g., by actuation of the MCP cable 394) can also cause rotation of the PIP input link 306 about the axis P3 as the PIP cables 364a, 364b change form to accommodate rotation of the proximal digit segment 304.

In some cases, some functionalities of the PIP cable drives 360a, 360b and MCP cable drive 395 may be consolidated at the remote location to allow fewer parts (e.g., fewer actuators). For example, one cable drive at the remote location (e.g., in the robotic forearm) may actuate both of the PIP cables 364a, 364b or both of the PIP cables 364a, 364b and the MCP cable 394.

### Example VI—Robot With Forearm Cable Drive for Actuation of Robotic Digit

FIG. 9 shows an example robot 400 having a humanoid upper body 402 including a torso 404, a head 406, arms 408a, 408b, and hands 410a, 410b. Each of the hands 410a, 410b can include one or more robotic digits 412, which may have any combination of the features of the robotic digit 300 described in Examples I-V.

For illustrative purposes, a cable 414 is shown extending from a joint link 411 in a robotic digit 412a to a cable drive 416 in a forearm 417 of the arm 408a. In the illustrated example, the cable 414 extends through a wrist 418 of the hand 410a. The cable 414 may be any of the PIP cables and MCP cables described in Examples II-V. The cable drive 416 may be any of the PIP cable drives and MCP drive described in Examples II-V. Although only one cable 414 is shown extending from the robotic digit 412a to the forearm 417 in FIG. 9, there can be multiple cables extending from the robotic digit 412a to the forearm 417 as described in Examples III-V.

### Additional Examples

Additional examples based on principles described herein are enumerated below. Further examples falling within the scope of the subject matter can be configured by, for example, taking one feature of an example in isolation, taking more than one feature of an example in combination, or combining one or more features of one example with one or more features of one or more other examples.

Example 1: A robotic digit, comprising: a first segment coupled to one end of a second segment by a first flexible coupling; a third segment coupled at one end to another end of the second segment through a second flexible coupling; a main actuator coupled through a linkage to the second segment, wherein movement of the main actuator causes corresponding motion of the second segment across the first flexible coupling; and at least a first actuator in fixed relation to the first segment and coupled to one end of a first cable, another end of the first cable coupled to either the third segment or to a fourth segment coupled to the third segment, wherein movement of the second segment relative to the first segment causes corresponding movement of the third segment across the second flexible coupling.

Example 2: The robotic digit according to example 1, wherein the at least a first actuator comprises a capstan onto which the one end of the first cable is attached, wherein rotation of the capstan causes change in a length of the first cable and corresponding change in a relative angle between the first flexible coupling and the second flexible coupling.

Example 3: The robotic digit according to Example 1 or Example 2, wherein the first flexible coupling enables pivoting about a single axis.

Example 4: The robotic digit according to Example 1 or Example 2, wherein the second flexible coupling enables pivoting about a single axis parallel to the single axis of the first flexible coupling.

Example 5: The robotic digit according to any of Examples 1-4, wherein the first flexible coupling enables pivoting about two mutually orthogonal axes.

Example 6: The robotic digit according to Example 5 further comprising at least a second actuator in fixed relation to the first segment, the at least a second actuator coupled to one end of a second cable, the second cable coupled at another end to the third segment or a fourth segment functionally coupled at one end to an end of the third segment, and wherein synchronous motion of the at least a first and the at least a second actuator causes flexion motion across the second flexible coupling relative to the first flexible coupling, and differential motion of the at least a first and the at least a second actuator causes abduction motion across the first flexible coupling.

Example 7: The robotic digit according to Example 6 wherein the other end of the first cable and the other end of the second cable are coupled to the third segment or the fourth segment through a respective spring.

Example 8: The robotic digit according to Example 1, wherein the third segment is coupled to the fourth segment through a third flexible coupling and wherein the first cable is coupled at one end to the fourth segment, wherein motion of the main actuator causes corresponding flexural motion of the second segment relative to the first segment, the third segment relative to the second segment, and the fourth segment relative to the third segment.

Example 9: The robotic digit according to any of Examples 1-6 wherein the other end of the first cable is coupled to the third segment or the fourth segment through a spring.

Example 10: A robotic hand, comprising: a plurality of digits coupled to a hand, at least one of the digits comprising a first segment coupled to one end of a second segment by a first flexible coupling, a third segment coupled at one end to another end of the second segment through a second flexible coupling, a main actuator coupled through a linkage to the second segment, wherein movement of the main actuator causes corresponding motion of the second segment across the first flexible coupling and at least a first actuator in fixed relation to the first segment and coupled to one end of a first cable, another end of the cable coupled to either the third segment or to a fourth segment coupled to the third segment, wherein movement of the second segment relative to the first segment causes corresponding movement of the third segment across the second flexible coupling.

Example 11: The robotic hand of example 10, wherein the at least a first actuator comprises a capstan onto which the one end of the first cable is attached, wherein rotation of the capstan causes change in a length of the first cable and corresponding change in a relative angle between the first flexible coupling and the second flexible coupling.

Example 12: The robotic hand of Example 10 or 11 wherein the first flexible coupling enables pivoting about a single axis.

Example 13: The robotic hand of Example 12 wherein the second flexible coupling enables pivoting about a single axis parallel to the single axis of the first flexible coupling.

Example 14: The robotic hand of any of Examples 10-13 wherein the first flexible coupling enables pivoting about two mutually orthogonal axes.

Example 15: The robotic hand of any of Examples 10-14 wherein the other end of the first cable is coupled to the third segment or the fourth segment through a spring.

Example 16: The robotic hand of Example 14 further comprising at least a second actuator in fixed relation to the first segment, the at least a second actuator coupled to one end of a second cable, the second cable coupled at another end to the third segment or a fourth segment functionally coupled at one end to an end of the third segment, and wherein synchronous motion of the at least a first and the at least a second non-back-drivable actuators causes flexion motion across the second flexible coupling relative to the first flexible coupling, and differential motion of the at least a first and the at least a second actuator causes abduction motion across the first flexible coupling.

Example 17: The robotic hand of Example 16 wherein the other end of the first cable and the other end of the second cable are coupled to the third segment or the fourth segment through a respective spring.

Example 18: The robotic hand of Example 10 wherein the third segment is coupled to the fourth segment through a third flexible coupling and wherein the first cable is coupled at one end to the fourth segment, wherein motion of the main actuator causes corresponding flexural motion of the second segment relative to the first segment, the third segment relative to the second segment and the fourth segment relative to the third segment.

Example 19: A robot, comprising: a hand portion coupled to an arm portion. The arm portion is coupled to a torso portion. The torso portion is coupled to a lower body portion. The lower body portion is coupled to at least one leg portion, wherein the hand portion comprises a plurality of digits coupled to a hand, at least one of the digits comprising a first segment coupled to one end of a second segment by a first flexible coupling, a third segment coupled at one end to another end of the second segment through a second flexible coupling, a main actuator coupled through a linkage to the second segment, wherein movement of the main actuator causes corresponding motion of the second segment across the first flexible coupling and at least a first actuator in fixed relation to the first segment and coupled to one end of a first cable, another end of the cable coupled to either the third segment or to a fourth segment coupled to the third segment, wherein movement of the second segment relative to the first segment causes corresponding movement of the third segment across the second flexible coupling.

Example 20: The robot of example 19 wherein the at least a first actuator comprises a capstan onto which the one end of the first cable is attached, wherein rotation of the capstan causes change in a length of the first cable and corresponding change in a relative angle between the first flexible coupling and the second flexible coupling.

Example 21: The robot of Example 19 or 20 wherein the first flexible coupling enables pivoting about a single axis.

Example 22: The robot of Example 19 or 20 wherein the second flexible coupling enables pivoting about a single axis parallel to the single axis of the first flexible coupling.

Example 23: The robot of Example 19 or 20 wherein the first flexible coupling enables pivoting about two mutually orthogonal axes.

Example 24: The robot of any of Examples 19-23 wherein the other end of the first cable is coupled to the third segment or the fourth segment through a spring.

Example 25: The robot of any of Examples 19-24 further comprising at least a second actuator in fixed relation to the first segment, the at least a second actuator coupled to one end of a second cable, the second cable coupled at another end to the third segment or a fourth segment functionally coupled at one end to an end of the third segment, and wherein synchronous motion of the at least a first and the at least a second actuator causes flexion motion across the second flexible coupling relative to the first flexible coupling, and differential motion of the of the at least a first and the at least a second actuator causes abduction motion across the first flexible coupling.

Example 26: The robot of Example 25 wherein the other end of the first cable and the other end of the second cable are coupled to the third segment or the fourth segment through a respective spring.

Example 27: The robot of any of Examples 19-26 wherein the third segment is coupled to the fourth segment through a third flexible coupling and wherein the first cable is coupled at one end to the fourth segment, wherein motion of the main actuator causes corresponding flexural motion of the second segment relative to the first segment, the third segment relative to the second segment and the fourth segment relative to the third segment.

Example 28: A method, comprising: operating a main actuator having an output coupled to a movable part of a robotic digit to effect flexural motion of the movable part relative to a fixed part of the digit, the digit comprising a first segment coupled to one end of a second segment by a first flexible coupling, a third segment coupled at one end to another end of the second segment through a second flexible coupling, the main actuator coupled through a linkage to the second segment, wherein movement of the main actuator causes corresponding motion of the second segment across the first flexible coupling and at least a first actuator in fixed relation to the first segment and coupled to one end of a first cable, another end of the cable coupled to either the third segment or to a fourth segment coupled to the third segment, wherein movement of the second segment relative to the first segment causes corresponding movement of the third segment across the second flexible coupling.

Example 29: The method of Example 28 further comprising operating the at least a first actuator and at least a second actuator, the at least a second actuator being disposed in fixed relation to the first segment, the at least a second actuator coupled to one end of a second cable, the second cable coupled at another end to the third segment or a fourth segment functionally coupled at one end to an end of the third segment, and wherein synchronous operation of the at least a first actuator and the at least a second actuator causes flexion motion across the second flexible coupling relative to the first flexible coupling, and differential operation of the at least a first actuator and the at least a second actuator causes abduction motion across the first flexible coupling.

A robotic digit according to any of Examples 1-29, a robotic hand made with such digit, and a robot using one or more of such hands may provide better control over gripping force, may provide more human like ability to grip objects and may provide gripping force related only to the output of a single, main actuator.

Example 31: A robotic digit comprising: a digit base; a joint link coupled to the digit base and movable relative to the digit base about a first axis; a proximal digit segment coupled to the joint link and movable relative to the joint link about a second axis, wherein the second axis is orthogonal to the first axis; an input link coupled to the proximal digit segment, the input link movable relative to the proximal digit segment about a third axis, wherein the third axis is orthogonal to the second axis; a first cable extending along the proximal digit segment, the first cable having a distal end coupled to the input link; and a first cable drive coupled to a proximal end of the first cable, wherein the first cable drive is operable to move the first cable relative to the proximal digit segment, wherein relative movement between the first cable and the proximal digit segment causes movement of the input link about the third axis.

Example 32: A robotic digit according to Example 31, further comprising: a second cable extending along the proximal digit segment, the second cable having a distal end coupled to the input link; and a second cable drive coupled to a proximal end of the second cable, wherein the second cable drive is operable to move the second cable relative to the proximal digit segment, wherein relative movement between the second cable and the proximal digit segment causes movement of the input link about the third axis; wherein differential motion of the first cable and the second cable relative to each other cause movement of the proximal digit segment and the input link about the second axis.

Example 33: A robotic digit according to Example 32, wherein the first cable drive comprises a first cable drive actuator having an output coupled to the proximal end of the first cable, and wherein the second cable drive comprises a second cable drive actuator having an output coupled to the proximal end of the second cable.

Example 34: A robotic digit according to Example 33, further comprising a main actuator having an output coupled to the joint link and operable to move the joint link about the first axis, wherein the first cable and the second cable couple movement of the joint link about the first axis to movement of the input link about the third axis.

Example 35: A robotic digit according to Example 34, wherein the main actuator has a higher payload capacity compared to each of the first cable drive actuator and the second cable drive actuator.

Example 36: A robotic digit according to Example 35, wherein the main actuator is a backdrivable actuator, and wherein each of the first cable drive actuator and the second cable drive actuator is a non-backdrivable actuator.

Example 37: A robotic digit according to Example 34, wherein the main actuator is a cable drive actuator, and further comprising a main cable having a distal end coupled to the joint link and a proximal end coupled to the output of the main actuator.

Example 38: A robotic digit according to Example 37, wherein the main actuator is externally located relative to the proximal digit segment and the digit base.

Example 39: A robotic digit according to Example 34, wherein the main actuator is coupled to the digit base, and wherein the output of the main actuator is coupled to the joint link by a mechanical linkage.

Example 40: A robotic digit according to Example 34, wherein the first cable drive actuator and the second cable drive actuator are externally located relative to the digit base and proximal digit segment.

Example 41: A robotic digit according to Example 34, wherein the first cable drive actuator and the second cable drive actuator are coupled to the digit base.

Example 42: A robotic digit according to Example 41, wherein a longitudinal position of the first cable drive actuator along the digit base is the same as a longitudinal position of the second cable drive actuator along the digit base.

Example 43: A robotic digit according to Example 32, further comprising a pair of cable guides disposed on opposite sides of the proximal digit segment or on opposite sides of the digit base, wherein each of the first cable and the second cable engages one of the pair of cable guides via a sliding contact or a rolling contact.

Example 44: A robotic digit according to Example 43, wherein the cable guides are idler pulleys.

Example 45: A robotic digit according to Example 31, wherein the first cable drive comprises a first cable drive actuator having an output coupled to the proximal end of the first cable.

Example 46: A robotic digit according to Example 45, wherein the first cable drive actuator is a non-backdrivable actuator.

Example 47: A robotic digit according to any of Examples 45-46, wherein the first cable drive further comprises: a capstan drive drum supported for movement about a fourth axis, wherein the proximal end of the first cable is attached to the capstan drive drum such that movement of the capstan drive drum about the fourth axis reels the first cable around the capstan drive drum, and wherein the output of the first cable drive actuator is coupled to move the capstan drive drum about the fourth axis.

Example 48: A robotic digit according to Example 47, wherein the capstan drive drum is coupled to the digit base and movable relative to the digit base about the fourth axis, and wherein the fourth axis is parallel to the first axis.

Example 49: A robotic digit according to Example 47, wherein the first cable drive further comprises a gear arrangement to translate the output of the first cable drive actuator to movement of the capstan drive drum about the fourth axis.

Example 50: A robotic digit according to Example 49, wherein the gear arrangement comprises: a worm wheel supported for movement about the fourth axis and coupled to the capstan drive drum; and a worm gear coupled to an output of the cable drive actuator and enmeshed with the worm gear.

Example 51: A robotic digit according to any of Examples 45-50, wherein the first cable drive is coupled to the digit base.

Example 52: A robotic digit according to any of Examples 45-51, further comprising a cable guide disposed on the proximal digit segment or the digit base, wherein the first cable engages the cable guide with a sliding contact or a rolling contact.

Example 53: A robotic digit according to Example 52, wherein the cable guide is an idler pulley.

Example 54: A robotic digit according to any of Examples 45-53, further comprising a main actuator having an output coupled to the joint link and operable to move the joint link about the first axis, wherein the first cable moves relative to the proximal digit segment in response to movement of the joint link about the first axis.

Example 55: A robotic digit according to Example 54, wherein the main actuator is a backdrivable actuator.

Example 56: A robotic digit according to any of Examples 54-55, further comprising a return spring coupling the input link to the proximal digit segment.

Example 57: A robotic digit according to any of Examples 54-56, wherein the main actuator is coupled to the joint link through a mechanical linkage.

Example 58: A robotic digit according to Example 57, wherein the mechanical linkage comprises: a screw shaft coupled to the output of the second actuator; a nut disposed on the screw shaft and movable along the screw shaft by movement of the screw shaft about an axial axis of the screw shaft; and at least one linkage bar having a proximal end pivotably coupled to the nut and a distal end pivotably coupled to the joint link.

Example 59: A robotic digit according to any of Examples 54-58, wherein the main actuator is coupled to the digit base.

Example 60: A robotic digit according to any of Examples 31-59, further comprising an intermediate digit segment pivotably coupled to the input link.

Example 61: A robotic digit according to Example 60, further comprising a first return spring coupling the intermediate digit segment to the proximal digit segment and a second return spring coupling the input link to the proximal digit segment.

Example 62: A robotic digit according to any of Examples 60-61, further comprising a distal digit segment coupled to the intermediate digit segment via a fixed joint or an actuated joint.

Example 63: A robotic digit according to Example 62, further comprising a haptic sensor coupled to the distal digit segment.

Example 64: A robotic arm comprising: a forearm; a hand coupled to the forearm by a wrist, the hand having at least one digit comprising: a digit base; a joint link coupled to the digit base and movable relative to the digit base about a first axis; a proximal digit segment coupled to the joint link and movable relative to the joint link about a second axis, wherein the second axis is orthogonal to the first axis; an input link coupled to the proximal digit segment, the input link movable relative to the proximal digit segment about a third axis, wherein the third axis is orthogonal to the second axis; a first cable extending along the proximal digit segment, the first cable having a distal end coupled to the input link; and a first cable drive disposed in the forearm and coupled to a proximal end of the first cable, wherein the first cable drive is operable to move the first cable relative to the proximal digit segment, wherein relative movement between the first cable and the proximal digit segment causes movement of the input link about the third axis.

Example 65: A robotic arm according to Example 64, wherein the at least one digit further comprises a second cable having a distal end coupled to the input link and extending along the proximal digit segment.

Example 66: A robotic arm according to Example 65, further comprising a second cable drive disposed in the forearm and coupled to a proximal end of the second cable, wherein the second cable drive is operable to move the second cable relative to the proximal digit segment, and wherein differential motion of the first cable and the second cable relative to each other cause movement of the proximal digit segment and the input link about the second axis.

Example 67: A robotic arm according to Example 66, wherein the at least one digit further comprises a main actuator coupled to the digit base and having an output coupled to the joint link, wherein the main actuator is operable to move the joint link about the first axis, and wherein the first cable and the second cable couple movement of the joint link about the first axis to movement of the input link about the third axis.

Example 68: A robotic arm according to Example 66, wherein the at least one digit further comprises a third cable having a distal end coupled to the joint link, wherein movement of the third cable relative to the digit base causes movement of the joint link about the first axis.

Example 69: A robotic arm according to Example 68, further comprising a third cable drive disposed in the forearm and coupled to a proximal end of the third cable, wherein the third cable drive is operable to move the third cable relative to the digit base.

Example 70: A robotic arm comprising: a forearm; a hand coupled to the forearm by a wrist, the hand having at least one digit comprising: a digit base; a joint link coupled to the digit base and movable relative to the digit base about a first axis; a proximal digit segment coupled to the joint link and movable relative to the joint link about a second axis, wherein the second axis is orthogonal to the first axis; an input link coupled to the proximal digit segment, the input link movable relative to the proximal digit segment about a third axis, wherein the third axis is orthogonal to the second axis; a first cable extending along the proximal digit segment, the first cable having a distal end coupled to the input link; a first cable drive coupled to the digit base and operatively coupled to a proximal end of the first cable, wherein the first cable drive is operable to move the first cable relative to the proximal digit segment, wherein relative movement between the first cable and the proximal digit segment causes movement of the input link about the third axis; and a second cable extending along the digit base, the second cable having a distal end coupled to the joint link; and a second cable drive disposed in the forearm and coupled to a proximal end of the second cable, wherein the second cable drive is operable to move the second cable relative to the digit base, wherein relative movement between the second cable and the digit base causes movement of the joint link about the first axis.

Example 71: A robotic arm according to Example 70, wherein the at least one digit further comprises: a third cable extending along the proximal digit segment, the third cable having a distal end coupled to the input link; and a third cable drive coupled to the digit base and operatively coupled to a proximal end of the third cable, wherein the third cable drive is operable to move the third cable relative to the proximal digit segment, wherein relative movement between the third cable and the proximal digit segment causes movement of the input link about the third axis; wherein differential motion of the first cable and the third cable relative to each other cause movement of the proximal digit segment and the input link about the second axis.

Example 72: A robotic digit comprising: a digit base; a joint link coupled to the digit base and movable relative to the digit base about a first axis; a proximal digit segment coupled to the joint link; an input link coupled to the proximal digit segment, the input link movable relative to the proximal digit segment about a second axis, which may be parallel to the first axis in a neutral position of the proximal digit segment; a first cable extending along the proximal digit segment and having a distal end coupled to the input link, a first cable drive coupled to a proximal end of the first cable and operable to displace the first cable relative to the proximal digit segment; and a main actuator having an output coupled to the joint link and operable to move the joint link about the first axis, wherein movement of the joint link about the first axis causes relative displacement between the first cable and the proximal digit segment; wherein relative displacement between the first cable and the proximal digit segment via operation of the first cable drive or operation of the main actuator causes movement of the input link about the second axis.

Example 73: A robotic digit according to Example 72, further comprising: a second cable extending along the proximal digit segment and having a distal end coupled to the input link; and a second cable drive coupled to a proximal end of the second cable and operable to displace the second cable relative to the proximal digit segment.

Example 74: A robotic digit according to Example 73, wherein the proximal digit segment is movable relative to the joint link about a third axis orthogonal to the first axis and the second axis, wherein displacement of the first cable and the second cable relative to the proximal digit segment and synchronous motion of the first cable and the second cable relative to each other cause movement of the input link about the second axis, and wherein displacement of the first cable and the second cable relative to the proximal digit segment and differential motion of the first cable and the second cable relative to each other cause movement of the proximal digit segment about the third axis.

Example 75: A robotic digit according to Example 74, wherein the first cable drive comprises a first cable drive actuator having an output coupled to the proximal end of the first cable, and wherein the second cable drive comprises a second cable drive actuator having an output coupled to the proximal end of the second cable.

Example 76: A robotic digit according to Example 75, wherein the main actuator has a higher payload capacity compared to each of the first cable drive actuator and the second cable drive actuator.

Example 77: A robotic digit according to example 76, further comprising a main cable having a distal end coupled to the joint link and a proximal end coupled to the output of the main actuator, wherein the main actuator is operable to displace the main cable relative to the digit base, wherein displacement of the main cable relative to the digit base causes movement of the joint link about the first axis.

Example 78: A robotic digit according to Example 75, wherein the first cable drive actuator, the second cable drive actuator, and the main actuator are coupled to the digit base.

Example 79: A robotic digit according to Example 73, further comprising a pair of cable guides disposed on opposite sides of the proximal digit segment or on opposite sides of the digit base, wherein each of the first cable and the second cable engages one of the pair of cable guides via a sliding contact or a rolling contact.

Example 80: A robotic digit according to Example 72, wherein the first cable drive further comprises: a first cable drive actuator; and a first capstan drive drum supported for movement about a third axis, wherein the proximal end of the first cable is attached to the first capstan drive drum, wherein movement of the first capstan drive drum about the third axis reels the first cable around the first capstan drive drum, and wherein an output of the first cable drive actuator is coupled to move the first capstan drive drum about the third axis.

Example 81: A robotic digit according to Example 80, wherein the first capstan drive drum is coupled to the digit base and movable relative to the digit base about the third axis, and wherein the third axis is parallel to the first axis.

Example 82: A robotic digit according to any of Examples 80-81, wherein the first cable drive further comprises a gear arrangement to translate the output of the first cable drive actuator to movement of the first capstan drive drum about the third axis.

Example 83: A robotic digit according to Example 80, further comprising at least one cable guide disposed on the proximal digit segment or the digit base, wherein the first cable engages the at least one cable guide with a sliding contact or a rolling contact.

Example 84: A robotic digit according to Example 72, wherein the main actuator is coupled to the joint link through a mechanical linkage.

Example 85: A robotic digit according to Example 72, further comprising a distal digit segment coupled to the input link, wherein the distal digit segment provides at least a part of a fingertip structure.

Example 86: A robotic digit according to Example 85, further comprising an intermediate digit segment pivotably coupled to the input link, wherein the distal digit segment is attached to the intermediate digit segment and coupled to the input link through the intermediate digit segment.

Example 87: A robotic digit according to Example 86, further comprising a first return spring coupling the intermediate digit segment to the proximal digit segment and a second return spring coupling the input link to the proximal digit segment.

Example 88: A robotic digit according to Example 85, further comprising a haptic sensor coupled to the distal digit segment.

Example 89: A robotic digit according to Example 72, wherein the main actuator is a cable drive actuator disposed in a robotic forearm, and further comprising a main cable having a distal end coupled to the joint link and a proximal end coupled to the main actuator.

Example 90: A robotic digit according to Example 73, wherein the first cable drive and the second cable drive are disposed in a robotic forearm, and wherein the first cable and the second cable extend along the digit base to the robotic forearm.

Example 91: A robotic arm comprising: a forearm; a hand coupled to the forearm, the hand having at least one digit comprising: a digit base; a joint link coupled to the digit base and movable relative to the digit base about a first axis; a proximal digit segment coupled to the joint link; an input link coupled to the proximal digit segment, the input link movable relative to the proximal digit segment about a second axis, which may be parallel to the first axis in a neutral position of the proximal digit segment; a first cable extending along the proximal digit segment and having a distal end coupled to the input link; a first cable drive coupled to a proximal end of the first cable and operable to displace the first cable relative to the proximal digit segment, wherein relative movement between the first cable and the proximal digit segment causes movement of the input link about the second axis; and a main actuator having an output coupled to the joint link and operable to move the joint link about the first axis, wherein movement of the joint link about the first axis causes relative displacement between the first cable and the proximal digit segment; wherein at least one of the first cable drive or the main actuator is disposed in the forearm.

Example 92: A robotic arm according to Example 91, further comprising a main cable having a distal end coupled to the joint link and a proximal end coupled to the main actuator, wherein the main cable is disposed in the forearm and extends along the digit base, wherein the main actuator is operable to displace the main cable relative to the digit base, and wherein displacement of the main cable moves the joint link about the first axis.

Example 93: A method of actuating a robotic digit comprising: operating a main actuator having an output coupled to a joint link to rotate the joint link about a first axis, wherein an input link is coupled to the joint link through a proximal digit segment, wherein a distal end of a first cable extending along the proximal digit segment is coupled to the input link, and wherein rotation of the joint link about the first axis causes relative displacement between the first cable and the proximal digit segment and a corresponding rotation of the input link about a second axis; and operating a first cable drive actuator coupled to the first cable to cause further rotation of the input link about the second axis.

Example 94: A method of actuating a robotic digit comprising: operating a main actuator having an output coupled to a joint link to rotate the joint link about a first axis, wherein an input link is coupled to the joint link through a proximal digit segment, wherein distal ends of two cables extending along the proximal digit segment are coupled to the input link at spaced locations, and wherein rotation of the joint link about the first axis causes relative displacement between the two cables and the proximal digit segment and a corresponding rotation of the input link about a second axis; and synchronously operating a first cable drive actuator coupled to the first cable and a second cable drive actuator coupled to the second cable to cause further rotation of the input link about the second axis.

Example 95: A method according to Example 94, further comprising differentially operating the first cable drive actuator and the second cable drive actuator to cause movement of the proximal digit segment about a third axis, wherein the third axis is orthogonal to each of the second axis and the first axis.

1. A robotic digit comprising:
a digit base;
a joint link coupled to the digit base and movable relative to the digit base about a first axis;
a proximal digit segment coupled to the joint link;
an input link coupled to the proximal digit segment, the input link movable relative to the proximal digit segment about a second axis;
a first cable extending along the proximal digit segment and having a distal end coupled to the input link;
a first cable drive coupled to a proximal end of the first cable and operable to displace the first cable relative to the proximal digit segment; and
a main actuator having an output coupled to the joint link and operable to move the joint link about the first axis, wherein movement of the joint link about the first axis causes relative displacement between the first cable and the proximal digit segment;
wherein relative displacement between the first cable and the proximal digit segment via operation of the first cable drive or operation of the main actuator causes movement of the input link about the second axis.

2. The robotic digit of claim 1, further comprising:
a second cable extending along the proximal digit segment and having a distal end coupled to the input link; and
a second cable drive coupled to a proximal end of the second cable and operable to displace the second cable relative to the proximal digit segment.

3. The robotic digit of claim 2, wherein the proximal digit segment is movable relative to the joint link about a third axis orthogonal to the first axis and the second axis, wherein displacement of the first cable and the second cable relative to the proximal digit segment and synchronous motion of the first cable and the second cable relative to each other cause movement of the input link about the second axis, and wherein displacement of the first cable and the second cable relative to the proximal digit segment and differential motion of the first cable and the second cable relative to each other cause movement of the proximal digit segment about the third axis.

4. The robotic digit of claim 3, wherein the first cable drive comprises a first cable drive actuator having an output coupled to the proximal end of the first cable, and wherein the second cable drive comprises a second cable drive actuator having an output coupled to the proximal end of the second cable.

5. The robotic digit of claim 4, wherein the main actuator has a higher payload capacity compared to each of the first cable drive actuator and the second cable drive actuator.

6. The robotic digit of claim 5, further comprising a main cable having a distal end coupled to the joint link and a proximal end coupled to the output of the main actuator, wherein the main actuator is operable to displace the main cable relative to the digit base, wherein displacement of the main cable relative to the digit base causes movement of the joint link about the first axis.

7. The robotic digit of claim 4, wherein the first cable drive actuator, the second cable drive actuator, and the main actuator are coupled to the digit base.

8. The robotic digit of claim 2, further comprising a pair of cable guides disposed on opposite sides of the proximal digit segment or on opposite sides of the digit base, wherein each of the first cable and the second cable engages one of the pair of cable guides via a sliding contact or a rolling contact.

9. The robotic digit of claim 1, wherein the first cable drive comprises:
a first cable drive actuator; and
a first capstan drive drum supported for movement about a third axis, wherein the proximal end of the first cable is attached to the first capstan drive drum, wherein movement of the first capstan drive drum about the third axis reels the first cable around the first capstan drive drum, and wherein an output of the first cable drive actuator is coupled to move the first capstan drive drum about the third axis.

10. The robotic digit of claim 9, wherein the first capstan drive drum is coupled to the digit base and movable relative to the digit base about the third axis, and wherein the third axis is parallel to the first axis.

11. The robotic digit of claim 9, wherein the first cable drive further comprises a gear arrangement to translate the output of the first cable drive actuator to movement of the first capstan drive drum about the third axis.

12. The robotic digit of claim 9, further comprising at least one cable guide disposed on the proximal digit segment or the digit base, wherein the first cable engages the at least one cable guide with a sliding contact or a rolling contact.

13. The robotic digit of claim 1, wherein the main actuator is coupled to the joint link through a mechanical linkage.

14. The robotic digit of claim 1, further comprising a distal digit segment coupled to the input link, wherein the distal digit segment provides at least a part of a fingertip structure.

15. The robotic digit of claim 14, further comprising an intermediate digit segment pivotably coupled to the input link, wherein the distal digit segment is attached to the intermediate digit segment and coupled to the input link through the intermediate digit segment.

16. The robotic digit of claim 15, further comprising a first return spring coupling the intermediate digit segment to the proximal digit segment and a second return spring coupling the input link to the proximal digit segment.

17. The robotic digit of claim 14, further comprising a haptic sensor coupled to the distal digit segment.

18. A robotic arm comprising:
a forearm;
a hand coupled to the forearm, the hand having at least one digit comprising:
a digit base;
a joint link coupled to the digit base and movable relative to the digit base about a first axis;
a proximal digit segment coupled to the joint link;
an input link coupled to the proximal digit segment, the input link movable relative to the proximal digit segment about a second axis;
a first cable extending along the proximal digit segment and having a distal end coupled to the input link;
a first cable drive coupled to a proximal end of the first cable and operable to displace the first cable relative to the proximal digit segment; and
a main actuator having an output coupled to the joint link and operable to move the joint link about the first axis, wherein movement of the joint link about the first axis causes relative displacement between the first cable and the proximal digit segment;
wherein relative displacement between the first cable and the proximal digit segment via operation of the first cable drive or operation of the main actuator causes movement of the input link about the second axis; and
wherein at least one of the first cable drive or the main actuator is disposed in the forearm.

19. The robotic arm of claim 18, further comprising a main cable having a distal end coupled to the joint link and a proximal end coupled to the main actuator, wherein the main cable is disposed in the forearm and extends along the digit base, wherein the main actuator is operable to displace the main cable relative to the digit base, and wherein displacement of the main cable moves the joint link about the first axis.

20. A method of actuating a robotic digit comprising:
operating a main actuator having an output coupled to a joint link to rotate the joint link about a first axis, wherein an input link is coupled to the joint link through a proximal digit segment, wherein a distal end of a cable extending along the proximal digit segment is coupled to the input link, and wherein rotation of the joint link about the first axis causes relative displacement between the cable and the proximal digit segment and a corresponding rotation of the input link about a second axis; and
operating a cable drive actuator coupled to a proximal end of the cable to cause further rotation of the input link about the second axis.
